(19) United States
(12) Patent Application Publication
(10) Pub. No.: US 2024/0343270 A1
(43) Pub. Date: Oct. 17, 2024

(54) SIMULATION DEVICE FOR PROVING-GROUND BASED VEHICLE-IN-THE-LOOP SIMULATION TEST AND SIMULATION METHOD THEREOF

(71) Applicant: Kookmin University Industry Academy Cooperation Foundation, Seoul (KR)

(72) Inventors: Weon il SON, Seoul (KR); Tae Young OH, Daejeon (KR); Yun Chul HA, Seoul (KR); Jin Woo YOO, Seoul (KR)

(21) Appl. No.: 18/464,397

(22) Filed: Sep. 11, 2023

(30) Foreign Application Priority Data
Apr. 12, 2023 (KR) 10-2023-0048279

(51) Int. Cl. B60W 60/00; B60W 50/06

(52) U.S. Cl. CPC B60W 60/0025; B60W 50/06; B60W 2050/0088

(57) ABSTRACT

Disclosed is a simulation method of a simulation device. The simulation method includes generating a virtual road; synchronizing a location of an autonomous driving test vehicle in an actual proving ground (PG) with a location of a simulation vehicle on the virtual road; generating behavior of virtual traffic on the virtual road based on pre-stored actual behavior data of a target vehicle; generating virtual perception sensor data for the virtual traffic based on state information of the synchronized autonomous driving test vehicle and the behavior of the virtual traffic; and transmitting the virtual perception sensor data to the synchronized autonomous driving test vehicle.

### CROSS-REFERENCE TO RELATED APPLICATIONS

This application claims priority under 35 U.S.C. § 119 to Korean Patent Application No. 10-2023-0048279 filed on Apr. 12, 2023, in the Korean Intellectual Property Office, the disclosures of which are incorporated by reference herein in their entireties.

### BACKGROUND

Embodiments of the present disclosure described herein relate to a simulation device and a method of operating the same, and more particularly, relate to a simulation device for a PG-based VILS test and a method of operating the same.

Recently, autonomous driving systems have been rapidly developed to achieve the goal of fully autonomous driving. Because the purpose of an autonomous vehicle is to control the vehicle by itself without a driver's intervention, safety verification is very important to ensure the driver's safety.

A safety verification test scheme may be largely classified into a simulation-based test and a vehicle test. Although various simulation-based test methods such as Model-in-the-Loop (MIL), Software-in-the-Loop (SIL), and Hardware-in-the-Loop (HIL) are currently in use, in these simulation-based test methods, because a virtual vehicle dynamics model is applied and the occupant cannot feel the behavior of the vehicle, an error may occur between the behavior of the actual vehicle and the dynamic characteristics.

A vehicle test is used in the final operation of validating an autonomous algorithm because the vehicle test uses a real vehicle with real sensors and real surroundings. However, it is difficult to verify the effectiveness of an autonomous driving system that must respond to various dangerous traffic situations during testing through a vehicle test due to the expansion of an operational design domain (ODD).

Therefore, as a scheme for overcoming the limitations of a simulation-based test scheme and a vehicle test scheme, a vehicle-in-the-loop simulation (VILS)-based test scheme, which is a verification scheme based on a virtual environment and a real vehicle, has received considerable attention. The VILS may secure repeatability and reproducibility, and because surrounding objects and environments are expressed as virtual objects, the risk of collision can be significantly reduced compared to vehicle testing. In addition, it is possible to validate the autonomous driving system, reflect the dynamic characteristics of the actual vehicle, and reduce the cost required to prepare the test environment.

The VILS includes a dynamo-VILS scheme for testing a vehicle in a fixed chassis dynamo and a PG-VILS scheme for conducting a test based on a vehicle travelling in a proving ground (PG).

Among them, the PG-VILS has the same vehicle dynamics as in the vehicle test because the vehicle travels in an actual PG. In addition, a vehicle occupant can evaluate the acceptance of an autonomous driving system, and the environment construction cost is much lower than that of dynamo-VILS. Therefore, an efficient verification environment may be configured, and the effectiveness of an autonomous driving function may be verified by virtually implementing unexpected situations on a road, such as traffic jams.

Therefore, it is necessary to provide a technology capable of verifying the validity of an autonomous driving system by constructing a test system using PG-VILS.

### SUMMARY

Embodiments of the present disclosure provide a simulation device and a simulation method thereof capable of accurately reproducing a driving condition when testing an autonomous vehicle test and ensuring consistency between a vehicle test result and a VILS test result.

According to an embodiment, a simulation method of a simulation device includes generating a virtual road; synchronizing a location of an autonomous driving test vehicle in an actual proving ground (PG) with a location of a simulation vehicle on the virtual road; generating behavior of virtual traffic on the virtual road based on pre-stored actual behavior data of a target vehicle; generating virtual perception sensor data for the virtual traffic based on state information of the synchronized autonomous driving test vehicle and the behavior of the virtual traffic; and transmitting the virtual perception sensor data to the synchronized autonomous driving test vehicle.

In addition, the generating of the virtual road may include converting high-definition (HD) map data for an actual autonomous driving test bed into a universal transverse mercator (UTM) coordinate system.

In addition, the synchronizing may include receiving actual location information of the autonomous driving test vehicle; converting the actual location information into virtual location information on the virtual road; and transmitting the virtual location information to the autonomous driving test vehicle.

In addition, the actual location information may be converted into the virtual location information based on following equations:

$${X}_{vir} ( t ) = X ( t ) - ( {X}_{start} - {X}_{road} ) \\ {Y}_{vir} ( t ) = Y ( t ) - ( {Y}_{start} - {Y}_{road} ) \\ {ψ}_{vir} ( t ) = ψ ( t ) - ( {ψ}_{start} - {ψ}_{road} )$$

Wherein ( )_{road} represents a starting point of the virtual road, ( )ₛₜₐᵣₜ represents a point where the autonomous driving test vehicle is located at a start of a simulation, ( )ᵥᵢᵣ represents the virtual location information, X, Y represent a global location of the autonomous driving test vehicle, and ψ represents a direction value of the autonomous driving test vehicle.

In addition, the synchronizing may include generating continuous location information of the autonomous driving test vehicle by using an extrapolation method.

In addition, the pre-stored actual behavior data of the target vehicle may include data on a position, a speed and a direction of the target vehicle driven in a vicinity of the autonomous driving test vehicle during previously performed test driving of the autonomous driving test vehicle.

In addition, the generating of the behavior of the virtual traffic may include interpolating the pre-stored actual behavior data of the target vehicle by using a piecewise cubic hermite-interpolating-polynomial (PCHIP) method.

In addition, the virtual perception sensor data may include relative distance information and relative speed information between the synchronized simulation vehicle and the virtual traffic.

In addition, the state information of the synchronized autonomous driving test vehicle may include at least one of location information, speed information, and direction information measured by a real time kinematic global positioning system (RTK-GPS) mounted on the autonomous driving test vehicle.

In addition, the generating of the virtual perception sensor data may include generating the virtual perception sensor data by reflecting information about a distance between a RTK-GPS mounting location and a perception sensor mounting location of the autonomous driving test vehicle, information about a RTK-GPS mounting location of the target vehicle, and information about a point at which a perception sensor of the autonomous driving test vehicle detects the target vehicle.

In addition, the relative distance information may be calculated by following equations:

$$[ \begin{matrix}{RD}_{x} \\ {RD}_{y}\end{matrix} ] = [ \begin{matrix}{X}_{mea} - {X}_{sensor} \\ {Y}_{mea} - {Y}_{sensor}\end{matrix} ] [ \begin{matrix}cos ( - {ψ}_{ego} ) & - sin ( - {ψ}_{ego} \\ sin ( - {ψ}_{ego} ) & cos ( - {ψ}_{ego} )\end{matrix} ] \\ [ \begin{matrix}{X}_{sensor} \\ {Y}_{sensor}\end{matrix} ] = [ \begin{matrix}{d}_{x} \\ {d}_{y}\end{matrix} ] [ \begin{matrix}cos ( {ψ}_{ego} ) & - sin ( {ψ}_{ego} ) \\ sin ( {ψ}_{ego} ) & cos ( {ψ}_{ego} )\end{matrix} ] + [ \begin{matrix}{X}_{ego} \\ {Y}_{ego}\end{matrix} ] \\ [ \begin{matrix}{X}_{mea} \\ {Y}_{mea}\end{matrix} ] = [ \begin{matrix}- {l}_{x} \\ - {l}_{y}\end{matrix} ] [ \begin{matrix}cos ( {ψ}_{traf} ) & - sin ( {ψ}_{traf} ) \\ sin ( {ψ}_{traf} ) & cos ( {ψ}_{traf} )\end{matrix} ] + [ \begin{matrix}{X}_{traf} \\ {Y}_{traf}\end{matrix} ]$$

Wherein ( )ₛₑₙₛₒᵣ represents the perception sensor mounted on the autonomous driving test vehicle, ( )ₘₑₐ represents the point detected by the perception sensor mounted on the autonomous driving test vehicle, ( )_{ego} represents the synchronized simulation vehicle, ( )_{traf} represents the virtual traffic, X and Y represent global coordinates, RD represents the relative distance, d represents the distance between the RTK-GPS mounting location and the perception sensor mounting location of the autonomous driving test vehicle, and l represents a distance between the RTK-GPS mounting location of the target vehicle and a point detected by the perception sensor mounted on the autonomous driving test vehicle.

In addition, the relative distance information may be calculated by a following equation:

$$RV = {V}_{traf} - {V}_{ego}$$

Wherein ( )_{ego} represents the synchronized simulation vehicle, ( )_{traf} represents the virtual traffic, RV represents a relative speed, and V represents an absolute speed of a vehicle.

In addition, the generating of the virtual perception sensor data may include calculating error data by comparing the relative distance information and the relative speed information calculated based on the RTK-GPS with data of an actual perception sensor mounted on the autonomous driving test vehicle; and inserting normal distribution noise generated based on the calculated error data into the relative distance information and the relative speed information calculated based on the RTK-GPS.

In addition, the normal distribution noise may be generated through following equations:

$$μ = \frac{1}{n} {\sum }_{k = 1}^{n} {X}_{k} \\ {σ}^{2} = \frac{\sum {( X - μ )}^{2}}{n} \\ N ( μ , {σ}^{2} ) = \frac{1}{\sqrt{2 π {σ}^{2}}} * {e}^{- ( {( x - μ )}^{2} / 2 {σ}^{2} )}$$

Wherein μ represents an average of the error data, σ² represents a variance, n represents a total amount of the error data, and N(μ,σ²) represents a normal distribution with a mean and a variance as inputs.

In addition, the transmitting of the virtual perception sensor data may include transmitting the virtual perception sensor data to an autonomous electronic control unit (ECU) of the synchronized autonomous driving test vehicle through a controller area network (CAN), wherein the synchronized autonomous driving test vehicle is configured to perform autonomous driving based on the virtual perception sensor data.

According to another embodiment, a simulation device includes a communication unit that communicates with an autonomous driving test vehicle; and a processor, wherein the processor generates a virtual road, synchronizes location information of the autonomous driving test vehicle with a location of a simulation vehicle on the virtual road when location information of the location of the autonomous driving test vehicle in an actual proving ground (PG) is received through the communication unit, generates behavior of virtual traffic on the virtual road based on pre-stored actual behavior data of a target vehicle, generates virtual perception sensor data for the virtual traffic based on state information of the synchronized autonomous driving test vehicle and the behavior of the virtual traffic, and controls the communication unit to transmit the virtual perception sensor data to the synchronized autonomous driving test vehicle.

In addition, the virtual perception sensor data may include relative distance information and relative speed information between the synchronized simulation vehicle and the virtual traffic.

In addition, the processor may generate the virtual perception sensor data by reflecting information about a distance between a RTK-GPS mounting location and a perception sensor mounting location of the autonomous driving test vehicle, information about a RTK-GPS mounting location of the target vehicle, and information about a point at which the perception sensor of the autonomous driving test vehicle detects the target vehicle.

In addition, the relative distance information may be calculated by following equations:

$$[ \begin{matrix}{RD}_{x} \\ {RD}_{y}\end{matrix} ] = [ \begin{matrix}{X}_{mea} - {X}_{sensor} \\ {Y}_{mea} - {Y}_{sensor}\end{matrix} ] [ \begin{matrix}cos ( - {ψ}_{ego} ) & - sin ( - {ψ}_{ego} ) \\ sin ( - {ψ}_{ego} ) & cos ( - {ψ}_{ego} )\end{matrix} ] \\ [ \begin{matrix}{X}_{sensor} \\ {Y}_{sensor}\end{matrix} ] = [ \begin{matrix}{d}_{x} \\ {d}_{y}\end{matrix} ] [ \begin{matrix}cos ( {ψ}_{ego} ) & - sin ( {ψ}_{ego} ) \\ sin ( {ψ}_{ego} ) & cos ( {ψ}_{ego} )\end{matrix} ] + [ \begin{matrix}{X}_{ego} \\ {Y}_{ego}\end{matrix} ] \\ [ \begin{matrix}{X}_{mea} \\ {Y}_{mea}\end{matrix} ] = [ \begin{matrix}- {l}_{x} \\ - {l}_{y}\end{matrix} ] [ \begin{matrix}cos ( {ψ}_{traf} ) & - sin ( {ψ}_{traf} ) \\ sin ( {ψ}_{traf} ) & cos ( {ψ}_{traf} )\end{matrix} ] + [ \begin{matrix}{X}_{traf} \\ {Y}_{traf}\end{matrix} ]$$

Wherein ( )ₛₑₙₛₒᵣ represents a perception sensor mounted on the autonomous driving test vehicle, ( )ₘₑₐ represents the point detected by the perception sensor mounted on the autonomous driving test vehicle, ( )_{ego} represents the synchronized simulation vehicle, ( )_{traf} represents the virtual traffic, X and Y represent global coordinates, RD represents the relative distance, d represents the distance between the RTK-GPS mounting location and the perception sensor mounting location of the autonomous driving test vehicle, and L represents a distance between a RTK-GPS mounting location of the target vehicle and a point detected by the perception sensor mounted on the autonomous driving test vehicle.

According to still another embodiment, a non-transitory computer-readable recording medium in which, when executed by a processor of a simulation device, computer instructions that cause the simulation device to perform operations are stored, wherein the operations includes generating a virtual road; synchronizing a location of an autonomous driving test vehicle in an actual proving ground (PG) with a location of a simulation vehicle on the virtual road; generating behavior of virtual traffic on the virtual road based on pre-stored actual behavior data of a target vehicle; generating virtual perception sensor data for the virtual traffic based on state information of the synchronized autonomous driving test vehicle and the behavior of the virtual traffic; and transmitting the virtual perception sensor data to the synchronized autonomous driving test vehicle.

According to various embodiments of the present disclosure described above, it is possible to accurately reproduce driving conditions when testing an autonomous vehicle, and secure consistency between vehicle test results and VILS test results. Accordingly, it is possible to provide a PG-based VILS system capable of performing reliable validation of an autonomous vehicle.

### BRIEF DESCRIPTION OF THE FIGURES

The above and other objects and features of the present disclosure will become apparent by describing in detail embodiments thereof with reference to the accompanying drawings.

FIG. 1 is a diagram illustrating the concept of a proving ground (PG) based VILS system according to an embodiment of the present disclosure;

FIG. 2 is a diagram illustrating a configuration of a PG-based VILS system according to an embodiment of the present disclosure;

FIG. 3 is a block diagram illustrating the configuration of a simulation device according to an embodiment of the present disclosure;

FIG. 4A is a diagram illustrating road shape information of an HD map provided in latitude and longitude in angular units;

FIG. 4B is a diagram illustrating the result of converting the road shape information of FIG. 4A into the UTM coordinate system in meter units;

FIG. 5A is a diagram illustrating the concept of location synchronization between a real environment and a virtual environment;

FIG. 5B is a diagram illustrating a result of generating continuous location information using an extrapolation scheme;

FIG. 5C is a diagram illustrating a result of generating continuous location information using an extrapolation scheme;

FIG. 5D is a diagram illustrating a result of generating continuous location information using an extrapolation scheme;

FIG. 6A is a diagram illustrating the concept of perceptual sensor modeling according to an embodiment of the present disclosure;

FIG. 6B is a diagram illustrating a result generated through a perception sensor modeling process;

FIG. 6C is a diagram illustrating a result generated through a perception sensor modeling process;

FIG. 6D is a diagram illustrating a result generated through a perception sensor modeling process;

FIG. 6E is a diagram illustrating before and after performing sensor modeling using actual perceptual sensor data, respectively;

FIG. 6F is a diagram illustrating before and after performing sensor modeling using actual perceptual sensor data, respectively;

FIG. 6G is a diagram illustrating before and after performing sensor modeling using actual perceptual sensor data, respectively;

FIG. 7 is a block diagram illustrating a configuration of the autonomous driving test vehicle according to an embodiment of the present disclosure;

FIG. 8 is a diagram illustrating the operation of an autonomous driving ECU according to an embodiment of the present disclosure;

FIG. 9 is a diagram illustrating a procedure for confirming consistency between a vehicle test and a VILS test;

FIG. 10A is a diagram illustrating a test environment according to an embodiment of the present disclosure;

FIG. 10B is a diagram illustrating a test environment according to an embodiment of the present disclosure;

FIG. 10C is a diagram illustrating a test environment according to an embodiment of the present disclosure;

FIG. 10D is a diagram illustrating a test environment according to an embodiment of the present disclosure;

FIG. 11A is a diagram illustrating test result data according to an embodiment of the present disclosure;

FIG. 11B is a diagram illustrating test result data according to an embodiment of the present disclosure;

FIG. 11C is a diagram illustrating test result data according to an embodiment of the present disclosure;

FIG. 11D is a diagram illustrating test result data according to an embodiment of the present disclosure;

FIG. 11E is a diagram illustrating test result data according to an embodiment of the present disclosure;

FIG. 11F is a diagram illustrating test result data according to an embodiment of the present disclosure;

FIG. 11G is a diagram illustrating test result data according to an embodiment of the present disclosure;

FIG. 11H is a diagram illustrating test result data according to an embodiment of the present disclosure;

FIG. 12A is a diagram illustrating test result data according to an embodiment of the present disclosure;

FIG. 12B is a diagram illustrating test result data according to an embodiment of the present disclosure;

FIG. 12C is a diagram illustrating test result data according to an embodiment of the present disclosure;

FIG. 12D is a diagram illustrating test result data according to an embodiment of the present disclosure;

FIG. 12E is a diagram illustrating test result data according to an embodiment of the present disclosure;

FIG. 12F is a diagram illustrating test result data according to an embodiment of the present disclosure;

FIG. 12G is a diagram illustrating test result data according to an embodiment of the present disclosure;

FIG. 12H is a diagram illustrating test result data according to an embodiment of the present disclosure;

FIG. 12I is a diagram illustrating test result data according to an embodiment of the present disclosure;

FIG. 12J is a diagram illustrating test result data according to an embodiment of the present disclosure;

FIG. 13A is a diagram illustrating test result data according to an embodiment of the present disclosure;

FIG. 13B is a diagram illustrating test result data according to an embodiment of the present disclosure;

FIG. 13C is a diagram illustrating test result data according to an embodiment of the present disclosure;

FIG. 13D is a diagram illustrating test result data according to an embodiment of the present disclosure;

FIG. 13E is a diagram illustrating test result data according to an embodiment of the present disclosure;

FIG. 13F is a diagram illustrating test result data according to an embodiment of the present disclosure;

FIG. 13G is a diagram illustrating test result data according to an embodiment of the present disclosure;

FIG. 13H is a diagram illustrating test result data according to an embodiment of the present disclosure;

FIG. 14 is a flowchart illustrating a simulation method of a simulation device according to an embodiment of the present disclosure.

### DETAILED DESCRIPTION

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the disclosure. With regard to description of drawings, similar elements may be marked by similar reference numerals.

In describing the present disclosure, a detailed description of well-known technologies will be ruled out in order not to unnecessarily obscure the gist of the present disclosure. In addition, overlapping descriptions of the same components may be omitted.

The suffix “unit” that is mentioned in the elements used in the following description is merely used individually or in combination for the purpose of simplifying the description of the present disclosure. Therefore, the suffix itself will not be used to give a significance or function that differentiates the corresponding terms from one another.

Terms used in the present disclosure are used to describe specified examples of the present disclosure and are not intended to limit the scope of the present disclosure. Singular forms are intended to include plural forms unless the context clearly indicates otherwise.

In the present disclosure, terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

In addition, unless defined otherwise, terms used herein may have the same meanings as those generally understood by those skilled in the art to which the present disclosure pertains.

Hereinafter, various embodiments of the present disclosure will be described in detail with reference to the accompanying drawings.

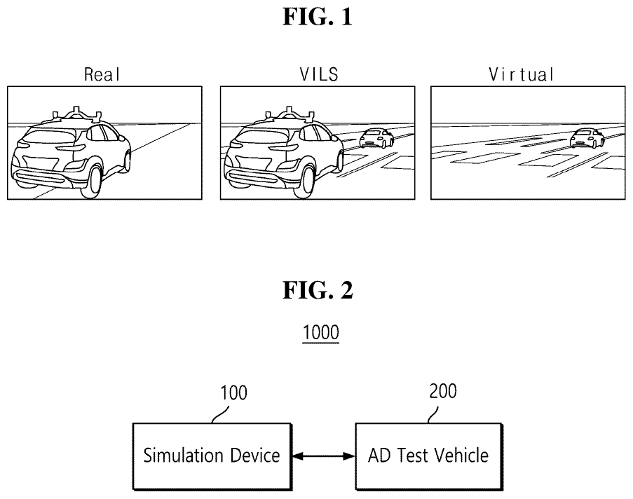

FIG. 1 is a diagram illustrating the concept of a proving ground (PG) based VILS system according to an embodiment of the present disclosure. Referring to FIG. 1, as shown in the “Real” part, in the PG-based VILS system, an autonomous driving test vehicle may travel on a real proving ground. In this case, the autonomous driving test vehicle may be equipped with an autonomous driving system to be tested, and may be autonomously driven by the autonomous driving system.

Meanwhile, as shown in the “Virtual” part of FIG. 1, in the PG-based VILS system, a simulation device may generate a virtual driving condition such as a virtual road, virtual traffic, or the like, and provide it to an autonomous driving test vehicle.

Accordingly, as shown in “VILS” of FIG. 1, the autonomous driving system may control the operation of the autonomous driving test vehicle according to the virtual driving condition received from the simulation device, such that the PG-based VILS test may proceed.

As described above, according to the PG-based VILS system according to an embodiment of the present disclosure, it is possible to test the response of an autonomous driving test vehicle under various conditions by configuring various virtual driving environments through the simulation device. Because virtual driving conditions are virtually implemented by the simulation device, such virtual driving conditions may be repeatable and reproducible, and the risk of collision may be significantly reduced compared to vehicle tests. In addition, because a test vehicle is driven in an actual PG, dynamic characteristics of an actual vehicle may be reflected in the driving test result.

FIG. 2 is a diagram illustrating a configuration of a PG-based VILS system according to an embodiment of the present disclosure. As shown in FIG. 2, a VILS system 1000 may include a simulation device 100 and an autonomous driving (AD) test vehicle 200.

The autonomous driving test vehicle 200 may include an autonomous driving electric control unit (ECU) that performs autonomous driving. The autonomous driving ECU may autonomously drive the autonomous driving test vehicle 200 by using data received from the simulation device 100.

The simulation device 100 may generate a virtual road environment and provide the virtual road environment to the autonomous driving test vehicle 200. The simulation device 100 may be mounted in the autonomous driving test vehicle 200, but is not limited thereto.

Data transmission and reception between the simulation device 100 generating a virtual environment and the autonomous driving test vehicle 200 operating in an actual PG may be performed using a controller area network (CAN) communication interface.

The autonomous driving test vehicle 200 may include a real time kinematic global positioning system (RTK-GPS). For interworking between the simulation device 100 and the autonomous driving test vehicle 200, state information (e.g., location information, direction information, speed information, and the like) measured through RTK-GPS may be transmitted to the simulation device 100.

Thereafter, virtual GPS data and virtual sensor data of the simulation device 100, necessary for autonomous driving control, may be transmitted to the autonomous driving ECU of the autonomous driving test vehicle 200. To this end, the simulation device 100 may generate a virtual road. The generated virtual road data may be used to synchronize the actual autonomous driving test vehicle 200 and the simulation vehicle in the virtual environment implemented by the simulation device 100. In addition, the simulation device 100 may model a virtual perception sensor by utilizing the state information of the synchronized autonomous driving test vehicle 200 and the behavior of virtual traffic. Accordingly, simulation similar to an actual vehicle test condition may be performed.

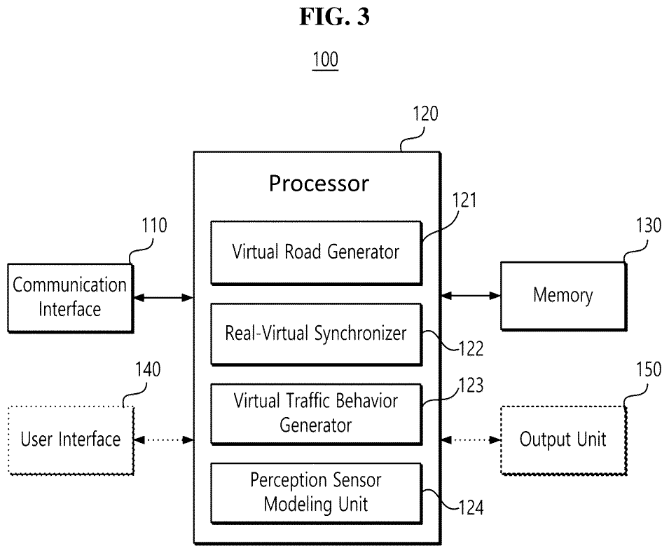

Hereinafter, the configuration and operation of the simulation device 100 according to various embodiments of the present disclosure will be described in detail with reference to FIGS. 3 to 6C.

FIG. 3 is a block diagram illustrating the configuration of a simulation device according to an embodiment of the present disclosure. Referring to FIG. 3, the simulation device 100 may include a communication interface 110, a processor 120, and a memory 130. According to an embodiment, the simulation device 100 may further include a user interface 140 or an output unit 150.

The communication interface 110 may transmit and receive data with the autonomous driving test vehicle 200. To this end, in particular, the communication interface 110 may include a controller area network (CAN) communication module.

According to an embodiment, the communication interface 110 may support various communication protocols capable of being wire or wirelessly connected to an external device. For example, the communication interface 110 may include at least one of a Wi-Fi communication module, a Bluetooth communication module, a near field communication (NFC) communication module, or a wired communication module.

According to an embodiment, the communication interface 110 may include a high definition multimedia (HDMI) interface, a universal serial bus (USB) interface, an SD card interface, or an audio interface in association with a connection terminal such as an HDMI connector, a USB connector, an SD card connector, or an audio connector (e.g., a headphone connector).

The communication interface 110 may provide the processor 120 with data received from an external device through the above-described communication path. In addition, the communication interface 110 may transmit data provided from the processor 120 to an external device through the above-described communication path.

The memory 130 may store various program codes or data required for operation of the simulation device. To this end, the memory 130 may include at least one of various types of flash memory, a random access memory (RAM), a read-only memory (ROM), a hard disk, a solid state drive (SSD), a card type memory (e.g., an SD or XD memory), a magnetic memory, a magnetic disk, and an optical disk. Meanwhile, the simulation device 100 may operate in relation to a web storage performing a storage function of the memory 130 on the Internet.

The user interface 140 may include various mechanical and electronic interfaces implemented in a device to receive information from a user, such as a touch interface, a microphone, a mouse, a keyboard, a button, and the like.

The output unit 150, which outputs various types of information generated by the simulation device 100 to an outside to transmit the information to the user, may include a display, an LED, a speaker, and the like.

The processor 120 controls the overall operation of the simulation device 100. The processor 120 may include one or more cores. The processor 120 may include at least one of a central processing unit (CPU), a general purpose graphics processing unit (GPGPU), an application processor (AP), a communication processor (CP), or a tensor processing unit (TPU), and may read program codes stored in the memory 130 to perform an operation of the simulation device 100 according to various embodiments of the present disclosure.

According to an embodiment, the processor 120 may include a virtual road generator 121, a real-virtual synchronizer 122, a virtual traffic behavior generator 123, and a perception sensor modeling unit 124.

The virtual road generator 121 may generate a virtual road. To conduct a driving test in a virtual environment, a virtual road environment is required.

According to an embodiment, the virtual road generator 121 may generate a virtual road by using high-definition (HD) map data for an actual autonomous driving test bed.

The HD map, which is an electronic map developed using recognition and positioning sensor data mounted in a mobile mapping system (MMS) vehicle, provides accurate location and road object attribute information in units of centimeters. The HD map is essential for an autonomous driving system that requires precise control of a vehicle, such as changing lanes, avoiding obstacles, and the like. The HD map is different from navigation and advanced driver assistance system (ADAS) maps that may only distinguish road units.

Meanwhile, the road shape information provided by the HD-MAP supports the world geodetic system 1984 (WGS84) coordinate system format. In the WGS84 coordinate system format, because a location on the earth's surface is expressed as latitude and longitude using an angle unit, usefulness and intuitiveness are reduced when implementing an autonomous driving system. Accordingly, according to an embodiment, the virtual road generator 121 may convert the HD map data for the autonomous driving test bed into a universal transverse Mercator (UTM) coordinate system in units of meters. In the case of the UTM coordinate system, it is easy to express distance and direction because all coordinates on the earth's surface are expressed as coordinates of X[m] and Y[m] based on a specific origin.

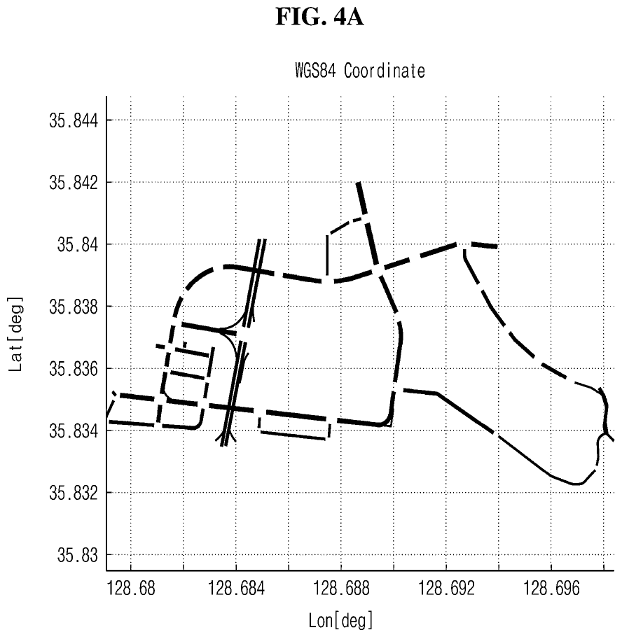

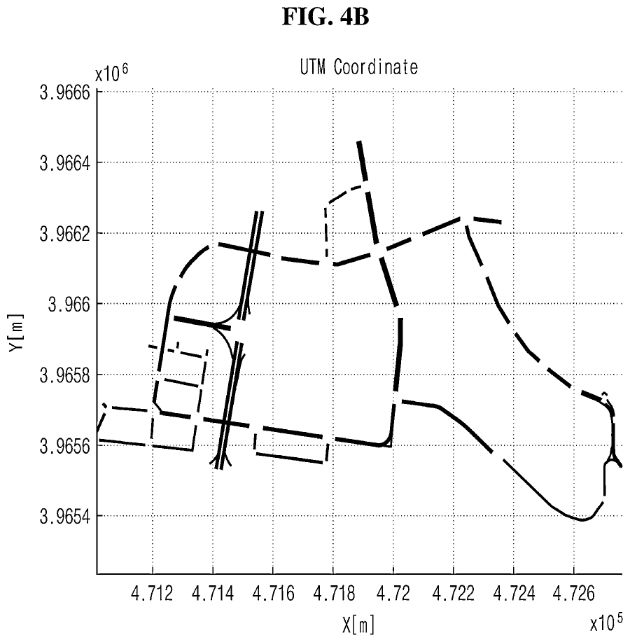

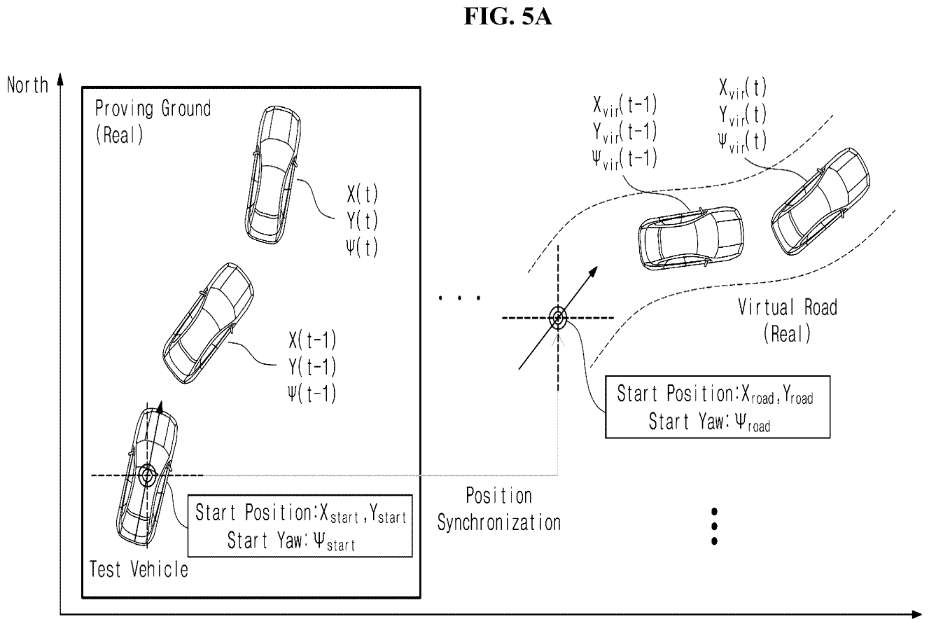

FIG. 4A is a diagram illustrating road shape information of an HD map provided in latitude and longitude in angular units. FIG. 4B is a diagram illustrating the result of converting the road shape information of FIG. 4A into the UTM coordinate system in units of meters.

The real-virtual synchronizer 122 may synchronize the location of the autonomous driving test vehicle in an actual proving ground and the location of the simulation vehicle on a virtual road.

In the case of the PG-based VILS, the actual location of the autonomous driving test vehicle 200 is not matched with the location of the simulation vehicle on the virtual road. Therefore, for the PG-based VILS test, a process of arranging the autonomous driving test vehicle 200 on the virtual road, that is, matching the location of the autonomous driving test vehicle 200 with the location of the simulation vehicle on the virtual road is required.

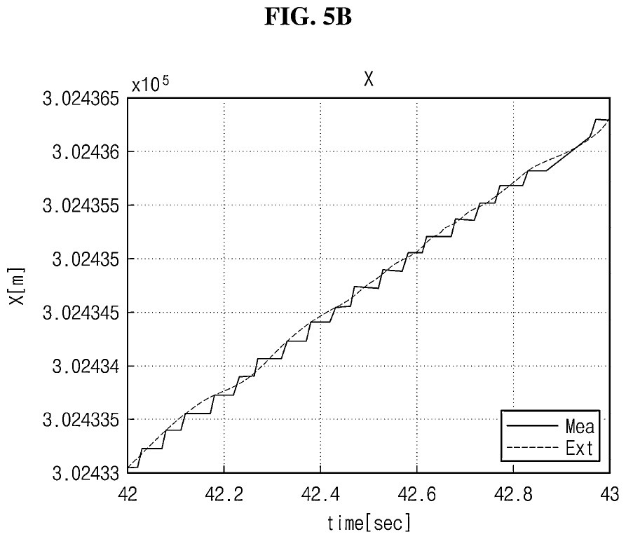

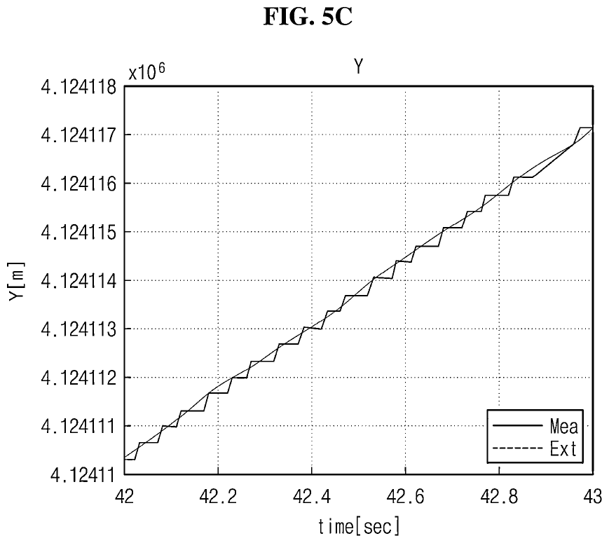

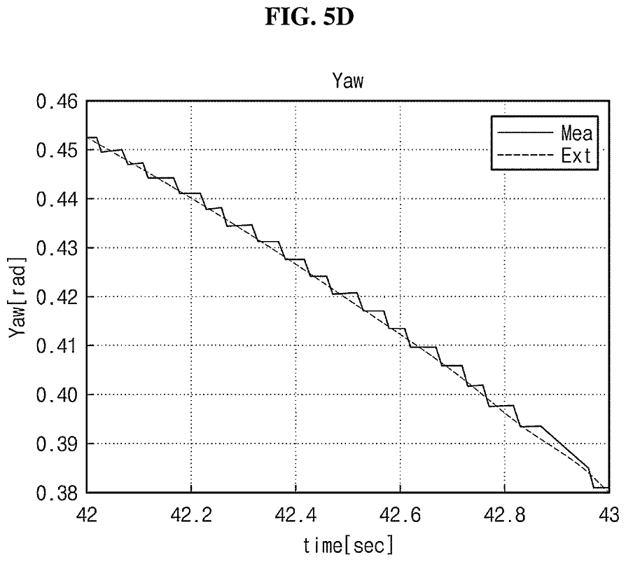

FIG. 5A is a diagram illustrating the concept of location synchronization between a real environment and a virtual environment. The real-virtual synchronizer 122 may receive the actual location information from the autonomous driving test vehicle 200 located on the PG, and convert the received actual location information into the virtual location information on the virtual road as shown in FIG. 5A, thereby synchronizing the locations of the real and virtual environments with each other.

According to an embodiment, the real-virtual synchronizer 122 may convert the actual location information of the autonomous driving test vehicle 200 into the virtual location information on a virtual road through following Equation 1.

$${X}_{vir} ( t ) = X ( t ) - ( {X}_{start} - {X}_{road} ) \\ {Y}_{vir} ( t ) = Y ( t ) - ( {Y}_{start} - {Y}_{road} ) \\ {ψ}_{vir} ( t ) = ψ ( t ) - ( {ψ}_{start} - {ψ}_{road} ) \qquad [ Equation 1 ]$$

Where ( )_{road} represents a starting point of the virtual road, ( )ₛₜₐᵣₜ represents a point where the autonomous test vehicle is located at a start of a simulation, ( )ᵥᵢᵣ represents the virtual location information, X and Y represent a global location of the autonomous test vehicle, and ψ represents a direction value of the autonomous test vehicle.

The virtual location information converted in such a manner may be transmitted to the autonomous driving test vehicle 200. Accordingly, the autonomous driving test vehicle 200 may be driven on a virtual road regardless of the actual location.

Meanwhile, because the actual location information received from the autonomous driving test vehicle 200 is information measured by the RTK-GPS mounted on the autonomous driving test vehicle 200, the actual location information is provided in terms of latitude and longitude. Accordingly, the real-virtual synchronizer 122 may convert the actual location information from the autonomous driving test vehicle 200 into UTM coordinate system values as described above and use the same.

Meanwhile, the measurement period (e.g., 10 Hz to 50 Hz) of the RTK-GPS sensor is different from the operation period (e.g., 100 Hz or more) of the simulation device 100. Therefore, for accurate simulation, it is necessary to continuously update the location information of the autonomous driving test vehicle 200 in synchronization with the operation cycle of the simulation device 100.

To this end, according to an embodiment, the real-virtual synchronizer 122 may generate continuous location information by using an extrapolation scheme based on the operation cycle of the simulation device 100.

FIGS. 5B to 5D are diagrams illustrating results of generating continuous location information using an extrapolation scheme. Because the cycle of the RTK-GPS data measurement value is lower than the simulation cycle, it may be understood that the data is displayed in a stepped shape such as “Mea” in each graph of FIGS. 5B to 5D. However, as shown in “Ext” of each graph of FIGS. 5B to 5D, it may be understood that continuous location information of the autonomous driving test vehicle 200 suitable for the simulation cycle can be generated by using an extrapolation scheme.

Meanwhile, in the case of an autonomous driving system, because it is necessary to respond to various dangerous situations that may occur due to surrounding vehicles on a road, it is important to understand the behavior of surrounding vehicles. In addition, it is important to accurately simulate the behavior of the target vehicle at a given time in order to simulate dangerous situations such as emergency steering and braking that may occur during vehicle testing through simulation and to verify the performance of an autonomous driving algorithm.

To this end, the virtual traffic behavior generator 123 may generate the behavior of virtual traffic on a virtual road based on pre-stored actual behavior data of the target vehicle. In this case, the previously stored actual behavior data of the target vehicle may include data on the location, speed, and direction of the target vehicle that was driven around the autonomous driving test vehicle during a previously performed test drive of the autonomous driving test vehicle.

For example, the location, speed and direction of an RTK-GPS installed in a target vehicle may first be recorded during vehicle testing. In this case, measurement data may be recorded based on GPS time provided by the RTK-GPS.

Meanwhile, the virtual traffic behavior generator 123 may obtain information about the target vehicle based on the vehicle test time. For example, the measurement data of the target vehicle may be received from the target vehicle in various manners and pre-stored in the memory 130, and the virtual traffic behavior generator 123 may obtain information about the target vehicle stored in the memory 130 based on the vehicle test time. Accordingly, the virtual traffic behavior generator 123 may generate the behavior of virtual traffic on the virtual road based on the obtained information on the target vehicle. In this case, because the location of the target vehicle is measured in latitude and longitude, as described above, the virtual traffic behavior generator 123 may generate the behavior of virtual traffic of the target vehicle by converting them into those of a UTM coordinate system.

Meanwhile, because the RTK-GPS data of the target vehicle is updated at a frequency lower than the simulation operation cycle of the simulation device 100, discontinuous virtual traffic behavior may be observed.

To solve this problem, the virtual traffic behavior generator 123 may generate virtual traffic behavior by interpolating actual behavior data of the target vehicle based on a simulation period. According to an embodiment, the virtual traffic behavior generator 123 may perform interpolation by using a piecewise cubic hermite-interpolating-polynomial (PCHIP) scheme, but is not limited thereto.

Meanwhile, the behavior of virtual traffic implemented as described above may not be measured through an actual perception sensor of the autonomous driving test vehicle 200. Therefore, in order to reflect the behavior of the generated virtual traffic in the simulation, the perception sensor modeling unit 124 may generate virtual perception sensor data on the virtual traffic based on the synchronized state information of the autonomous driving test vehicle and the behavior of the virtual traffic.

In addition, the perception sensor modeling unit 124 may generate perception sensor data that includes relative distance information and relative speed information between the synchronized simulation vehicle and the virtual traffic, based on state information (location information, speed information and direction information) of the autonomous driving test vehicle 200 measured by a real time kinematic global positioning system (RTK-GPS) mounted on the autonomous driving test vehicle 200 and the behavior of the virtual traffic generated by the virtual traffic behavior generator 123.

In this case, according to an embodiment, the perception sensor modeling unit 124 may determine a relative distance and a relative speed based on global position data of the autonomous driving test vehicle 200. However, in this case, because the location information of the actual perception sensor mounted on the autonomous driving test vehicle 200 is not reflected, the relative distance determined by the perception sensor modeling unit 124 may be different from the relative distance measured by the actual perception sensor. The difference may reduce consistency between a real vehicle test and an autonomous driving test using VILS, and make it difficult to secure repeatability and reproducibility of virtual traffic behavior.

Accordingly, according to an embodiment, the perception sensor modeling unit 124 may generate virtual perception sensor data by reflecting information about the distance between the RTK-GPS mounting location of the autonomous driving test vehicle 200, information about a RTK-GPS mounting location of the target vehicle, and the perception sensor mounting location and information about the location at which the perception sensor of the autonomous driving test vehicle 200 senses the target vehicle.

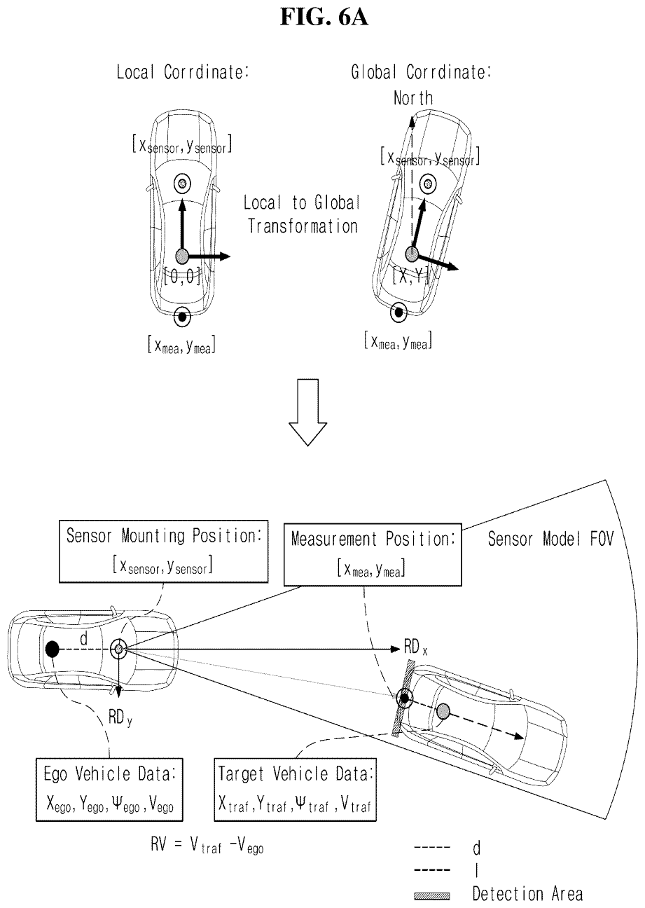

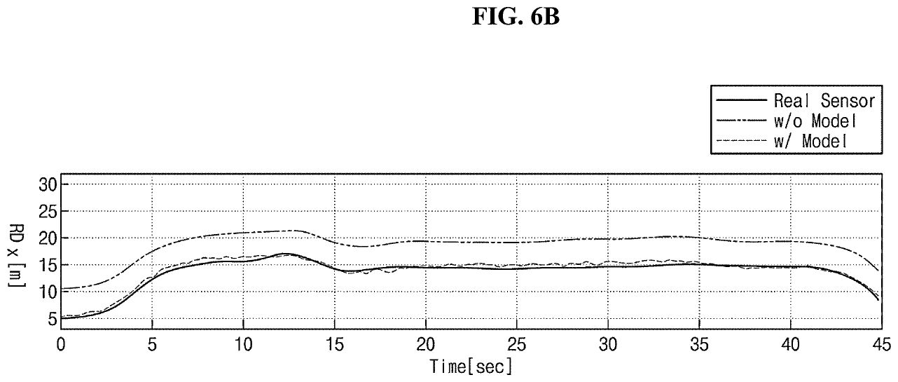

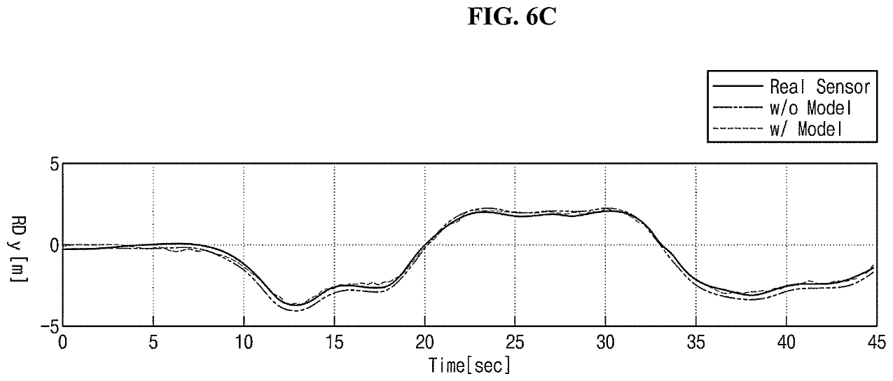

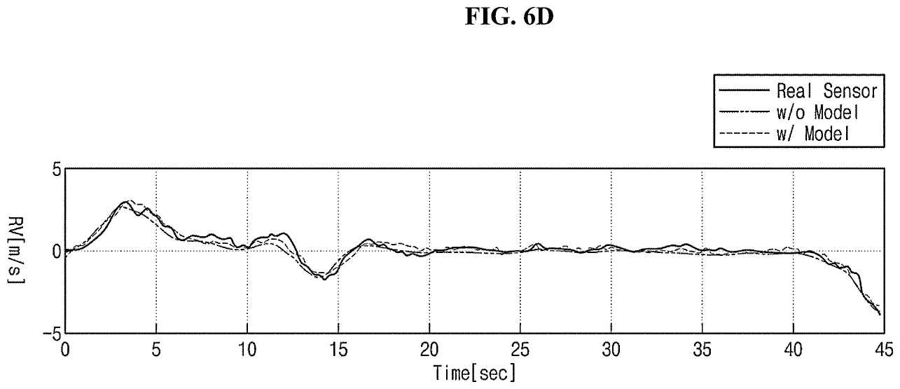

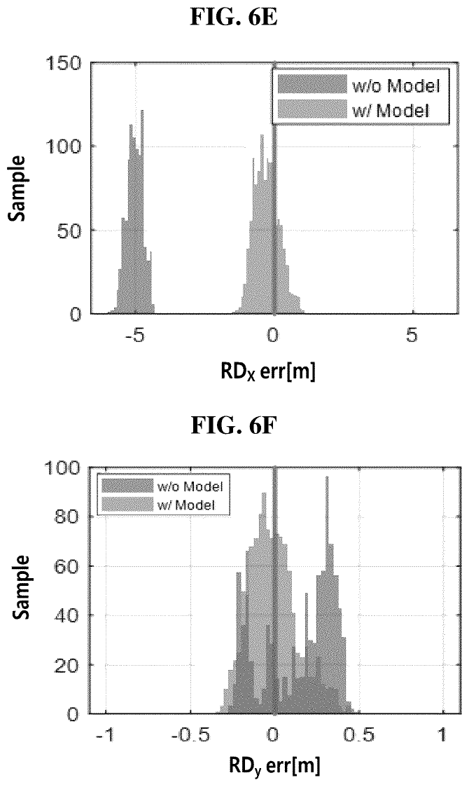

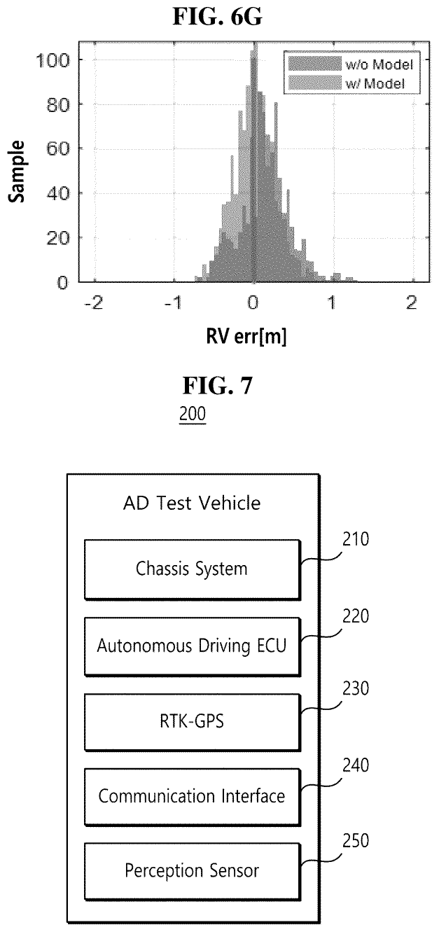

FIG. 6A is a diagram illustrating the concept of perceptual sensor modeling according to an embodiment of the present disclosure. Referring to FIG. 6A, the perception sensor modeling unit 124 may convert the RTK-GPS mounting location ([0,0]) of the autonomous driving test vehicle 200, the location ([xₛₑₙₛₒᵣ,yₛₑₙₛₒᵣ]) of the perception sensor based on the RTK-GPS mounting location, and the location ([xₘₑₐ,yₘₑₐ]) of a position at which the perception sensor senses the target vehicle based on the RTK-GPS mounting location to global coordinates ([X,Y], [Xₛₑₙₛₒᵣ,Yₛₑₙₛₒᵣ]), ([Xₘₑₐ,Yₘₑₐ]), respectively.

Accordingly, the perception sensor modeling unit 124 may calculate the relative distance through following Equation 2.

$$[ \begin{matrix}{RD}_{x} \\ {RD}_{y}\end{matrix} ] = [ \begin{matrix}{X}_{mea} - {X}_{sensor} \\ {Y}_{mea} - {Y}_{sensor}\end{matrix} ] [ \begin{matrix}cos ( - {ψ}_{ego} ) & - sin ( - {ψ}_{ego} ) \\ sin ( - {ψ}_{ego} ) & cos ( - {ψ}_{ego} )\end{matrix} ] \\ [ \begin{matrix}{X}_{sensor} \\ {Y}_{sensor}\end{matrix} ] = [ \begin{matrix}{d}_{x} \\ {d}_{y}\end{matrix} ] [ \begin{matrix}cos ( {ψ}_{ego} ) & - sin ( {ψ}_{ego} ) \\ sin ( {ψ}_{ego} ) & cos ( {ψ}_{ego} )\end{matrix} ] + [ \begin{matrix}{X}_{ego} \\ {Y}_{ego}\end{matrix} ] \\ [ \begin{matrix}{X}_{mea} \\ {Y}_{mea}\end{matrix} ] = [ \begin{matrix}- {l}_{x} \\ - {l}_{y}\end{matrix} ] [ \begin{matrix}cos ( {ψ}_{traf} ) & - sin ( {ψ}_{traf} ) \\ sin ( {ψ}_{traf} ) & cos ( {ψ}_{traf} )\end{matrix} ] + [ \begin{matrix}{X}_{traf} \\ {Y}_{traf}\end{matrix} ] \qquad [ Equation 2 ]$$

Wherein ( )ₛₑₙₛₒᵣ represents the perception sensor mounted on the autonomous test vehicle, ( )ₘₑₐ represents the point detected by the perception sensor mounted on the autonomous test vehicle, ( )_{ego} represents the synchronized simulation vehicle, ( )_{traf} represents the virtual traffic, X and Y represent global coordinates, RD represents the relative distance, d represents the distance between the RTK-GPS mounting location and the perception sensor mounting location of the autonomous test vehicle, and l represents a distance between a RTK-GPS mounting location of the target vehicle and a point detected by the perception sensor mounted on the autonomous test vehicle.

Meanwhile, the perception sensor modeling unit 124 may calculate the relative speed through following Equation 3.

$$RV = {V}_{traf} - {V}_{ego} \qquad [ Equation 3 ]$$

Where ( )_{ego} represents the synchronized simulation vehicle, ( )_{traf} represents the virtual traffic, RV represents a relative speed, and V represents an absolute speed of a vehicle.

Meanwhile, even though the relative distance and speed of the simulation vehicle (i.e., the synchronized autonomous driving test vehicle 200) and the virtual traffic are calculated by the above-described scheme, the noise component generated from the actual perception sensor is not reflected.

Accordingly, according to an embodiment, the perception sensor modeling unit 124 may implement sensor noise similar to those in real conditions by utilizing RTK-GPS data and perception sensor data obtained during a real vehicle test.

In addition, the perception sensor modeling unit 124 may compare the relative distance information and relative speed information calculated based on RTK-GPS with data of an actual perception sensor mounted in the autonomous driving test vehicle 200 to obtain error data, and may generate normal distribution noise based on the obtained error data. Accordingly, the perception sensor modeling unit 124 may insert the normal distribution noise into the relative distance information and relative speed information calculated based on RTK-GPS.

In this case, according to an embodiment, the perception sensor modeling unit 124 may generate normal distribution noise through following Equation 4.

$$μ = \frac{1}{n} {\sum }_{k = 1}^{n} {X}_{k} \\ {σ}^{2} = \frac{\sum {( X - μ )}^{2}}{n} \\ N ( μ , {σ}^{2} ) = \frac{1}{\sqrt{2 π {σ}^{2}}} * {e}^{- ( {( x - μ )}^{2} / 2 {σ}^{2} )} \qquad [ Equation 4 ]$$

Where μ represents an average of the error data, σ² represents a variance, n represents a total amount of the error data, and N(μ,σ²) represents a normal distribution with a mean and a variance as inputs.

FIGS. 6B to 6D are diagrams illustrating results generated through the above-described perception sensor modeling process. In addition, the graph of FIG. 6B illustrates the relative distance in the longitudinal direction, the graph of FIG. 6C illustrates the relative distance in the lateral direction, and the graph of FIG. 6D illustrates the relative speed. Referring to FIGS. 6B to 6D, in the case of a relative distance calculated using only RTK-GPS data without sensor modeling (w/o Model), errors are observed by comparison with actual perception sensor data (Real Sensor) that may affect vehicle control. However, it may be observed that the relative distance and speed (w/Model) generated through the above-described perceptual sensor modeling have a similar tendency to that of actual perception sensor data (Real Sensor).

FIGS. 6E to 6G are diagrams illustrating data error distributions before and after performing sensor modeling using actual perception sensor data as w/o model and w/model, respectively. It may be understood that the relative distance and relative speed in the case of sensor modeling show an average error distribution close to 0 (zero) compared to the data before sensor modeling. In the graphs of FIGS. 6F and 6G, dark colors represent overlapping portions of w/o model data and w/model data.

Meanwhile, the processor 120 may control the communication interface 110 to transmit the virtual perception sensor data generated as described above to the synchronized autonomous driving test vehicle 200.

According to an embodiment, the simulation device 100 may be implemented as a stand-alone electronic device, and may be mounted on the autonomous driving test vehicle 200 or disposed at a site where a VILS test is performed to perform the above-described operations. Alternatively, the simulation device 100 may be implemented as a server device, and may remotely communicate with the autonomous driving test vehicle 200 to perform the above-described operations.

FIG. 7 is a block diagram illustrating a configuration of the autonomous driving test vehicle 200 according to an embodiment of the present disclosure. Referring to FIG. 7, the autonomous driving test vehicle 200 may include a chassis system 210, an autonomous driving ECU 220, an RTK-GPS 230, a communication interface 240, and a perception sensor 250.

The chassis system 210 may include essential devices necessary for driving the autonomous driving test vehicle 200. For example, the chassis system 210 may include an engine as a power source for driving, various power transmission devices for transmitting power of the engine to driving wheels, various steering devices for adjusting a driving direction, various suspension devices for mitigating shock or vibration, various brake devices for stopping or parking, and the like.

The autonomous driving ECU 220 may control the operation of each component of the autonomous driving test vehicle 200. In particular, the autonomous driving ECU 220 may automatically control the movement (e.g., deceleration, acceleration, steering, and the like) of the autonomous driving test vehicle 200 based on various information obtained through the chassis system 210 or the perception sensor 250 and various information (e.g., virtual location information, virtual perception sensor data, and the like) received from the simulation device 100, such that the autonomous driving test vehicle 200 is automatically driven without any driver's interventions. To this end, the autonomous driving ECU 220 may include a processor such as a CPU, various memories, a CAN transceiver, and the like.

The RTK-GPS 230 may obtain global coordinates where the RTK-GPS 230 is located in real time, and based on the global coordinates, may measure the location, speed, acceleration, and rotation information of the autonomous driving test vehicle 200. The information measured through the RTK-GPS 230 may be transmitted to the simulation device 100 through the communication interface 240, and as described above, may be used to allow the simulation device 100 to implement the movement of a real vehicle in a virtual environment.

The communication interface 240 may perform communication between various components included in the autonomous driving test vehicle 200. In addition, the communication interface 240 may perform communication with the simulation device 100.

To this end, the communication interface 240 may include a wireless communication unit or a wired communication unit. The wireless communication unit may include at least one of a mobile communication module, a wireless Internet module, and a short-range communication module. The mobile communication module may transmit/receive radio signals to/from at least one of a base station, an external terminal, and a server on a mobile communication network constructed according to a mobile communication scheme such as long-term evolution (LTE). The wireless Internet module, which is a module for wireless Internet access, may support a communication scheme such as wireless LAN (WLAN), wireless-fidelity (Wi-Fi), Wi-Fi direct, digital living network alliance (DLNA), and the like. The short-range communication module, which is a module for transmitting and receiving data through short-range communication, may support a communication scheme such as Bluetooth™, radio frequency identification (RFID), infrared data association (IrDA), ultra wideband (UWB), ZigBee, near field communication (NFC), car area network (CAN), and the like. The wired communication unit may include a wired communication module capable of performing communication according to various wired communication standards such as 1000BASE-T, IEEE 802.3, high-definition multimedia interface (HDMI), universal serial bus (USB), IEEE 1394, and the like.

The perception sensor 250 may include various sensors for recognizing a surrounding situation. For example, the perception sensor 250 may include a LiDAR sensor, a radar sensor, a stereo camera, an ultrasonic sensor, and the like, but is not limited thereto.

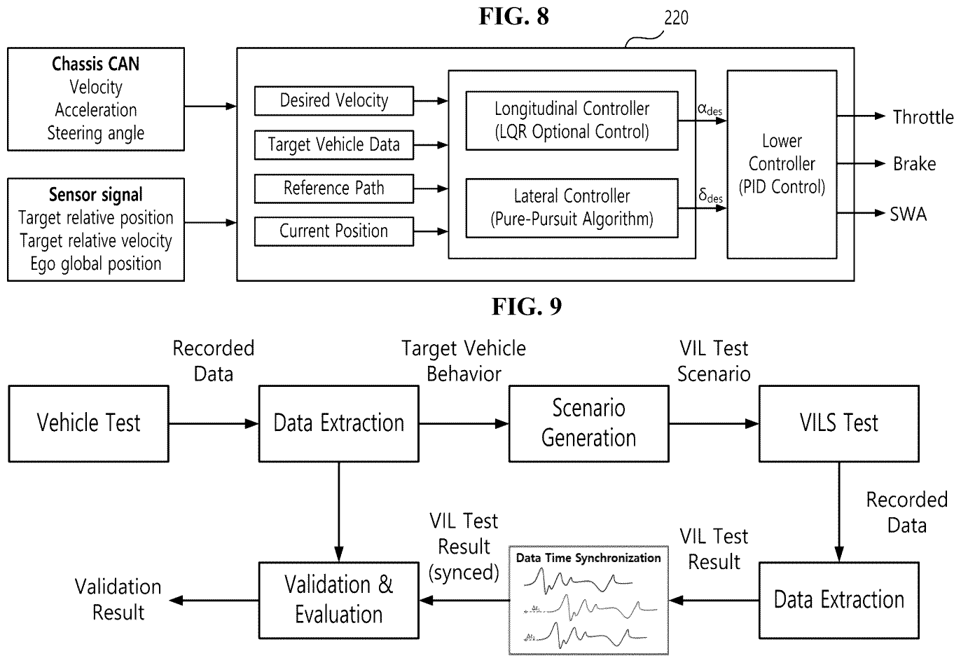

FIG. 8 is a diagram illustrating the operation of an autonomous driving ECU according to an embodiment of the present disclosure.

Even in the VILS test, like a vehicle test, the performance of a test vehicle equipped with an autonomous driving function must be verified. The VILS test may control the vehicle through the autonomous driving ECU 220 and verify the performance in real time based on the information obtained from the virtual driving environment. The autonomous driving test vehicle 200, which is a real vehicle to which an autonomous driving system is applied, is driven at a driving test site in the case of PG-VILS. The autonomous driving algorithm of PG-VILS may include longitudinal control to maintain distance from the target vehicle and lateral control to follow a specified route.

According to an embodiment, the autonomous driving ECU 220 may perform the longitudinal control based on the relative distance of the target vehicle and the relative speed of the target vehicle in order to keep the distance to the target vehicle. In detail, the autonomous driving ECU 220 may perform the longitudinal control by using the relative distance and relative speed obtained through the perception sensor 250 in a vehicle test situation. Meanwhile, the autonomous driving ECU 220 may perform the longitudinal control by using the relative distance and relative speed information included in virtual perception sensor data received from the simulation device 100 in a VILS test situation.

Meanwhile, the autonomous driving ECU 220 may perform the lateral control by using the location information of the autonomous driving test vehicle 200. In detail, the autonomous driving ECU 220 may perform the lateral control by using the global coordinates measured through the RTK-GPS 230 in a vehicle test situation. Meanwhile, the autonomous driving ECU 220 may perform the lateral control by using the virtual location information received from the simulation device 100 in a VILS test situation.

Referring to FIG. 8, the longitudinal controller of the autonomous driving ECU 220 may output a target acceleration α_{des} through linear quadratic regulator (LQR) optimization control. In addition, the lateral controller of the autonomous driving ECU 220 may output a target steering angle δ_{des} through a pure-pursuit algorithm. Each output value may be transmitted to a sub controller that controls an actuator of the autonomous driving test vehicle 200. The sub controller may generate a throttle/brake command for acceleration/deceleration of the autonomous driving test vehicle 200 and a steering wheel angle command for steering through proportional-integral-differential (PID) control.

FIG. 9 is a diagram illustrating a procedure for confirming consistency between a vehicle test and a VILS test.

The VILS system is required to verify an autonomous driving system, and verify whether test results obtained using VILS are similar to those of a vehicle test. This is because it is impossible to replicate and reproduce a vehicle test scenario using the VILS system when the behavior of a vehicle during the VILS test is different from that observed in the vehicle test.

Referring to FIG. 9, first, result data (control commands, vehicle states, and the like) necessary for verifying the behavior and consistency of a target vehicle necessary for generating a VILS scenario are extracted from various information obtained through a vehicle test. A VILS scenario is created using the extracted behavior of the target vehicle, and VILS test result data is extracted. In order to compare the results obtained by performing the same VILS scenario multiple times, time synchronization is performed based on the time of arrival (TOA), which is the time at which VILS test data reaches a specific value. Accordingly, it is possible to compare the time-synchronized VILS test results and vehicle test results to analyze consistency and verify the validity of the VILS system.

In this case, time series comparison for quantitatively verifying consistency between virtual data and real data and scalar data comparison used for key point data comparison of a test may be utilized.

In the time series comparison, a normalized root mean square error (NRMSE), which is an index of an error between two data sets, and Pearson correlation, which is an index of a linear correlation between two data sets, may be used.

The NRMSE is a value obtained by dividing a root mean square error (RMSE) value by a difference between maximum data and minimum data. The NRMSE may determine a normalized error with a value of 0 to 100 and may be expressed as in following Equation 5.

$$NRMSE = \frac{RMSE}{{y}_{real , max} - {y}_{real , min}} \times 100 = \\ \frac{\sqrt{\frac{1}{N} {\sum }_{i}^{N} {( {y}_{real , i} - {y}_{sim , i} )}^{2}}}{{y}_{real , max} - {y}_{real , min}} \times 100 \qquad [ Equation 5 ]$$

Where yᵣₑₐₗ and yₛᵢₘ represent real data and simulated data, respectively, N is the number of samples of the calculated data, and ( )ₘₐₓ and ( )ₘᵢₙ represent the maximum and minimum values, respectively.

The Pearson correlation is a value obtained by dividing the absolute value of the covariance of two data points by the square of the standard deviation of each data point. The Pearson correlation may be represented by a number between −1 and 1, and the closer to 1, the higher the correlation between data, and may be expressed as in following Equation 6.

$${r}_{sim , real} = \frac{\vert {\sum }_{i}^{N} ( {y}_{sim , i} - {\overline{y}}_{sim} ) \times ( {y}_{real , i} - {\overline{y}}_{real} ) \vert}{\sqrt{{\sum }_{i}^{N} {( {y}_{sim , i} - {\overline{y}}_{sim} )}^{2} \times {\sum }_{i}^{N} {( {y}_{real , i} - {\overline{y}}_{real} )}^{2}}} \qquad [ Equation 6 ]$$

Where r represents the Pearson correlation coefficient, yᵣₑₐₗ and yₛᵢₘ represent real data and simulated data, respectively, y̅ represents the average of the data, and N represents the number of samples of the measured data.

In the case of scalar data comparison, a relative error between virtual data and real data is determined as a ratio by comparing data peak values at a specific point in time. According to an embodiment, the peak value of the relative speed observed when the target vehicle suddenly stops may be compared with the peak value of the longitudinal acceleration of the autonomous driving test vehicle 200 performing autonomous emergency braking (AEB). Peak values of yaw rate and lateral acceleration are obtained when driving on a curved road with a large curvature, which will be described later. The relative error between the actual peak data and the virtual peak data may be expressed as following Equation 7.

$$PR = \frac{\vert {y}_{real , peak} - {y}_{sim , peak} \vert}{\vert {y}_{real , peak} \vert} \times 100 \qquad [ Equation 7 ]$$

Where PR represents the ratio of the actual simulation peak value, yᵣₑₐₗ and yₛᵢₘ represent the actual data and simulated data, respectively, and ( )ₚₑₐₖ represents the peak value of the compared data.

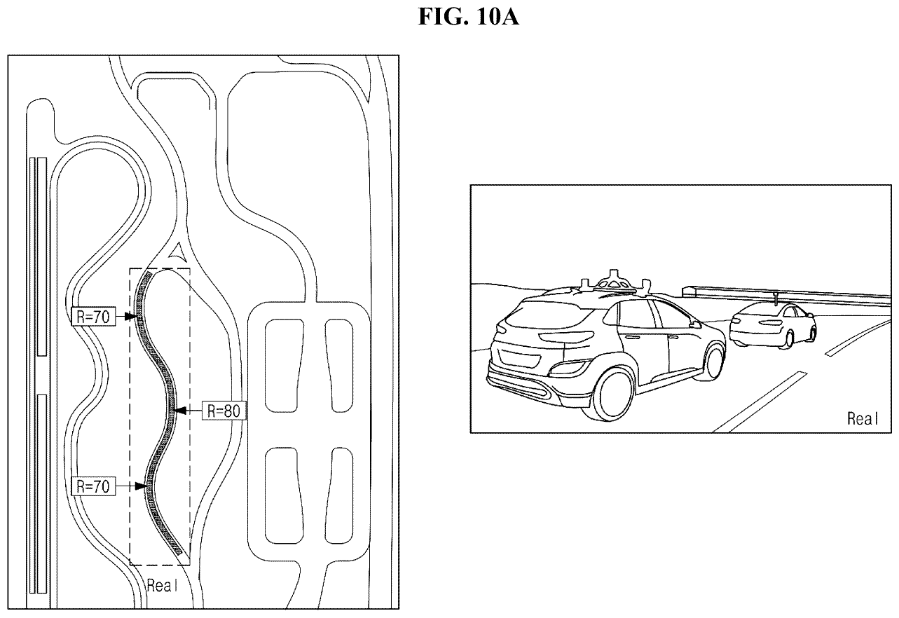

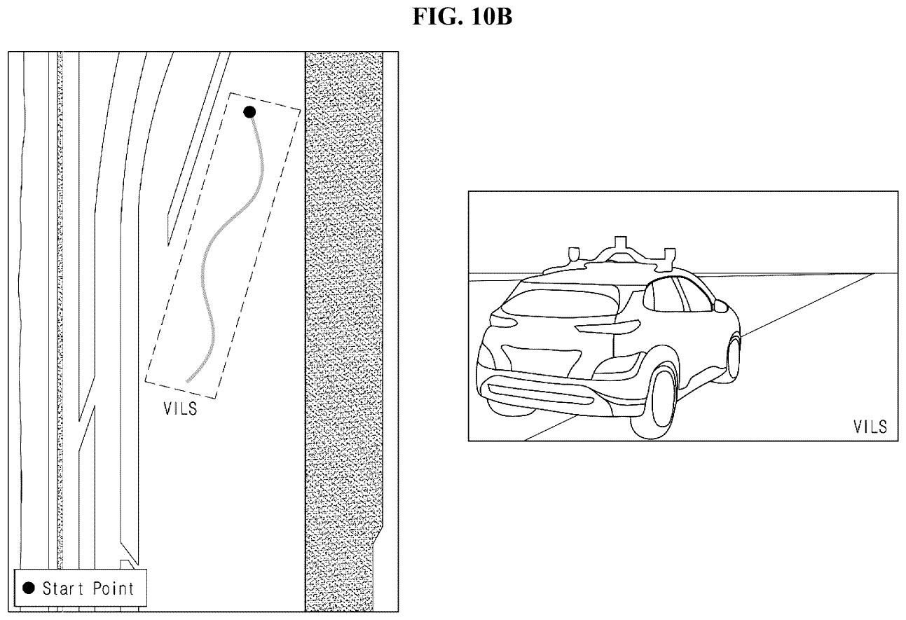

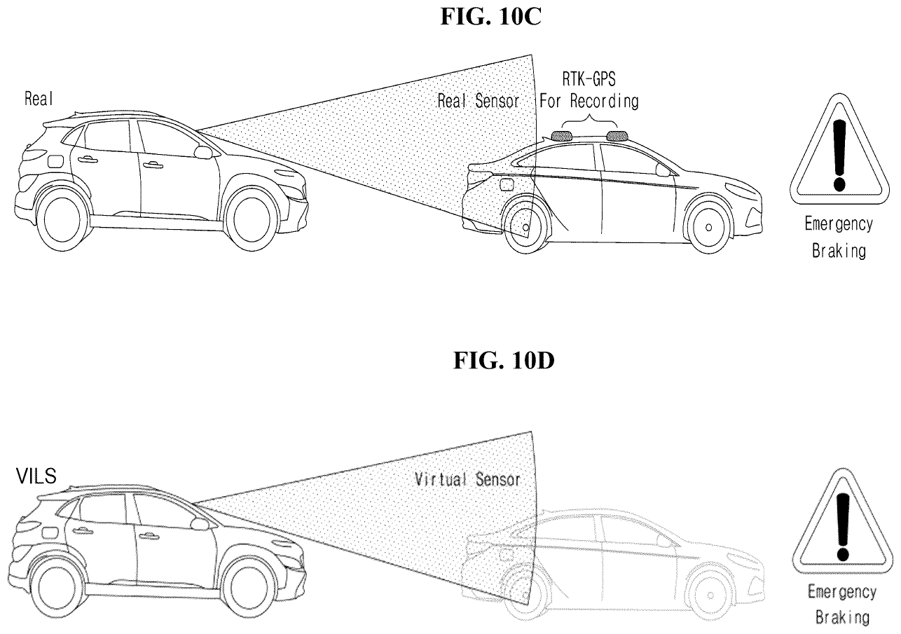

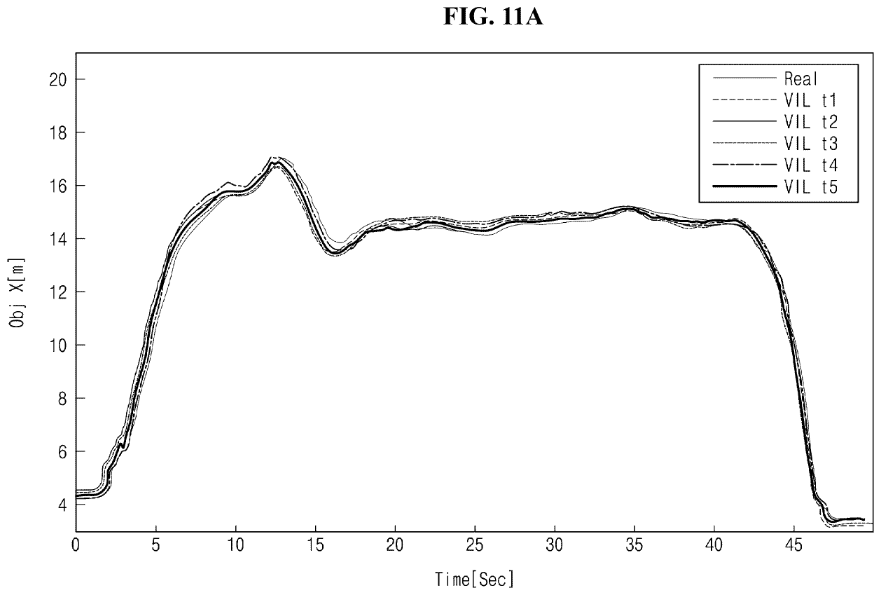

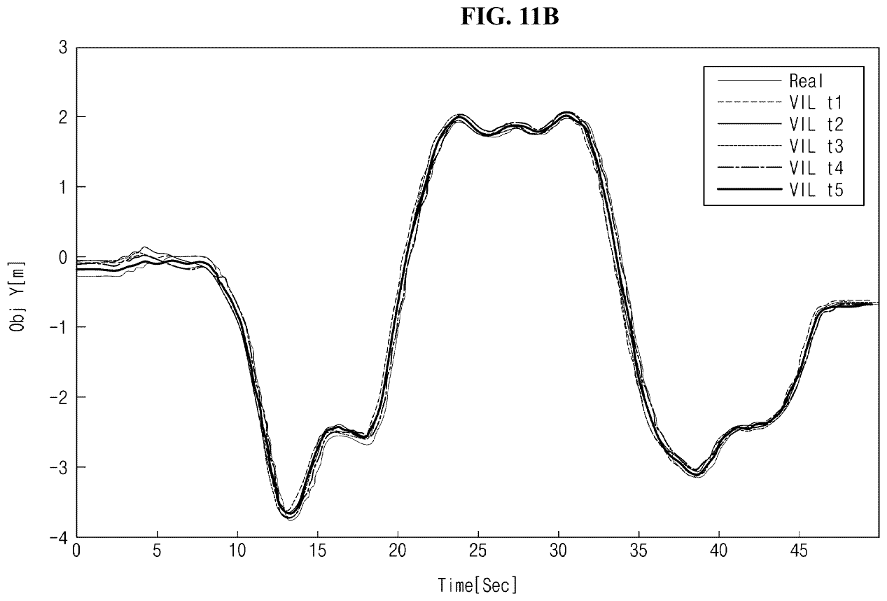

FIGS. 10A and 10B are diagrams illustrating a test environment according to an embodiment of the present disclosure. According to an embodiment, the actual vehicle test may be performed at a first driving test site, and the VILS test may be performed at a second driving test site different from the first driving test site.

Referring to FIG. 10A, the actual vehicle test may be performed on a selected target road (length of about 320 m) including curved sections having turning radii of 70 m, 80 m, and 70 m, respectively, in the first driving test site.

Referring to FIG. 10B, the VILS test may be performed by configuring a virtual road having the same shape as the target road of the first driving test site selected for the vehicle test in the second driving test site. That is, a partial area within the second driving test site allowing the target road size may be selected for the VILS test.

FIGS. 10C and 10D are diagrams illustrating a test environment according to an embodiment of the present disclosure.

FIG. 10C illustrates a configuration and scenario of an actual vehicle test performed using the target road of the first driving test site described with reference to FIG. 10A.

The target vehicle is equipped with an autonomous driving function together with manual driving. The target vehicle may be controlled to follow a specified path to keep a constant speed through cruise control. In addition, the target vehicle may record the measured operation by using the RTK-GPS installed therein. The recorded behavior information of the target vehicle may be used to implement the behavior of virtual traffic to be used in the VILS test.

The vehicle test scenario may include two types of autonomous driving and manual driving of the target vehicle. In the first scenario, adaptive cruise control (ACC) is performed on a target vehicle traveling autonomously along a specified route. In this scenario, the target vehicle may maintain a normal speed of 30 km/h and stop when sudden braking occurs at the end of the final curve (R=70 m).

In a second scenario, longitudinal and lateral control may be implemented in a manually driven target vehicle. The target vehicle may travel at a speed of 30 to 40 km/h and stop when sudden braking occurs at the end of the last curve, similar to the first scenario.

In both scenarios, the speed of the target vehicle may be set to a safe speed for the test by reflecting the width and curvature of the target road. In addition, in the case of a target vehicle manually driven by an actual driver, it is difficult for the target vehicle to travel at a constant speed over the entire section of the target road, so that the target vehicle is driven at a speed within a specific range. The autonomous driving test vehicle 200 may be set to 50 km/h faster than the driving speed of the target vehicle in order to correspond to the above two scenarios. The vehicle test may be performed using the scenario configured as described above, and the recorded behavior information of the target vehicle may be transmitted to the simulation device 100 and used to generate the virtual traffic behavior.

Meanwhile, as shown in FIG. 10D, the VILS test may be performed several times for each scenario, and the consistency of vehicle operation in the two environments may be verified by analyzing the VILS test result and the vehicle test result.

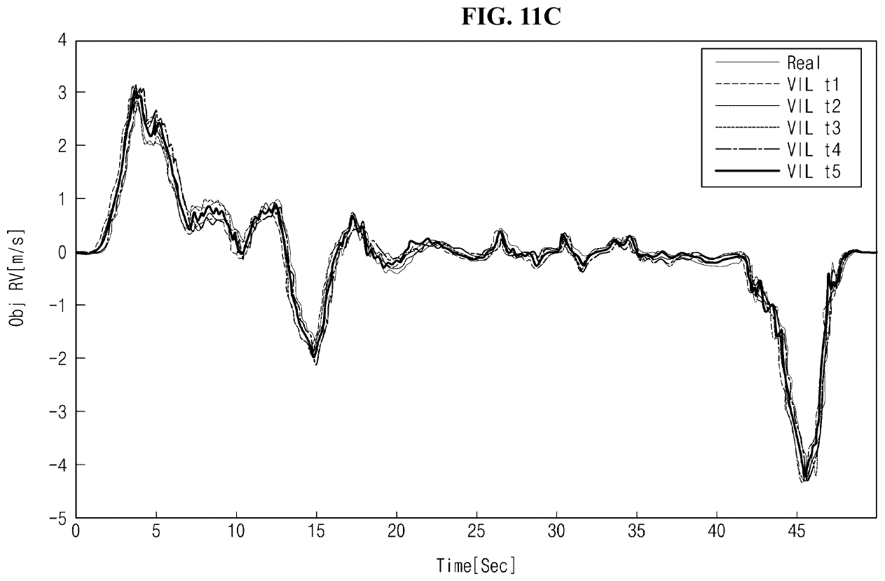

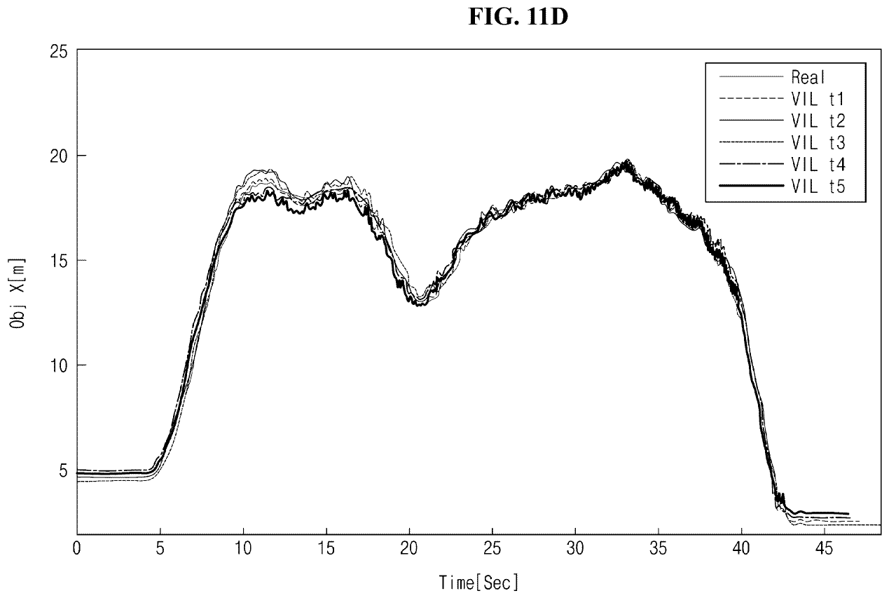

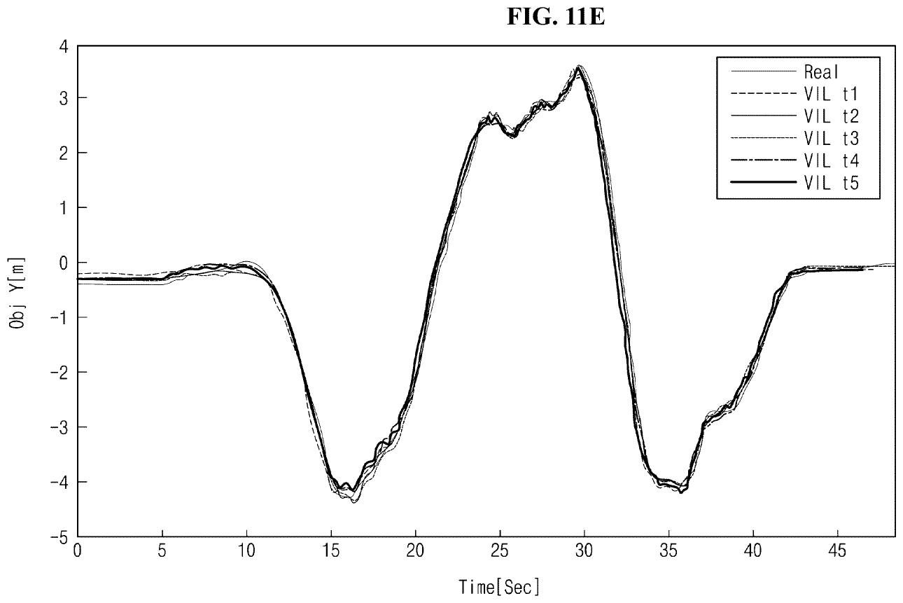

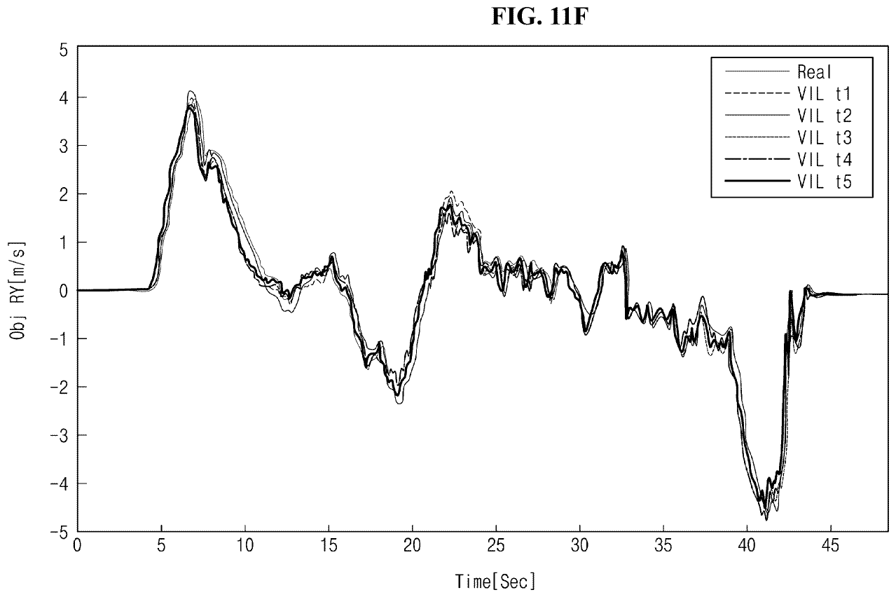

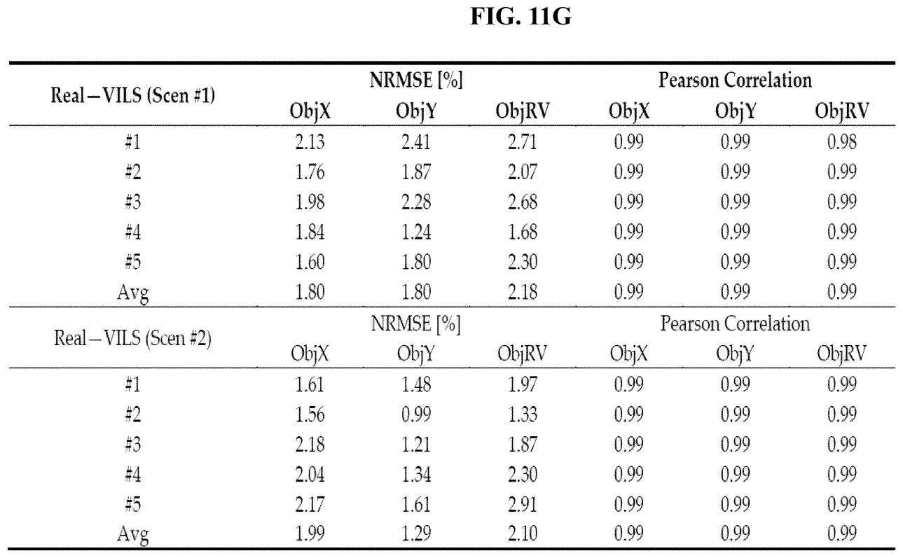

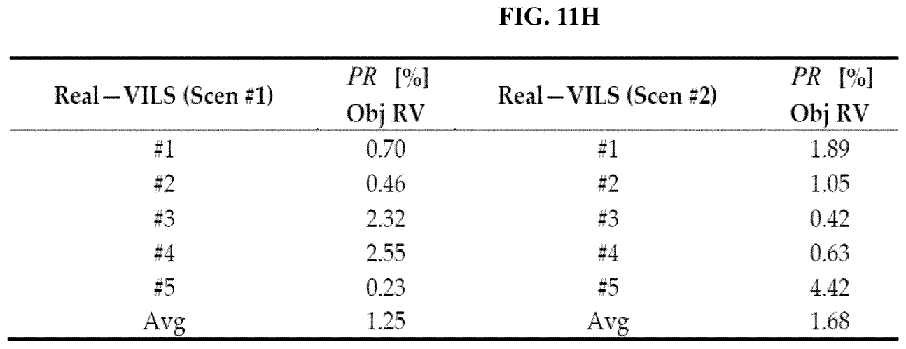

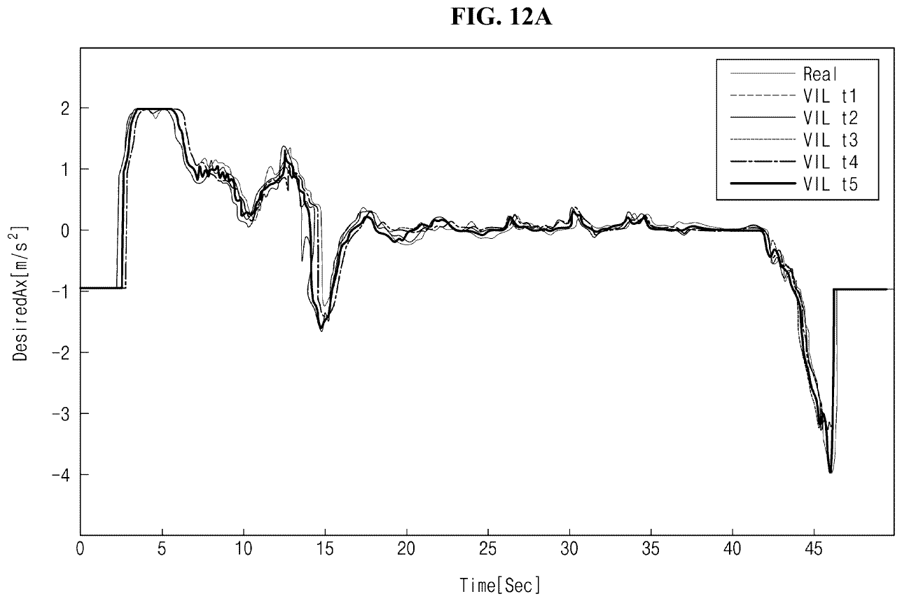

Hereinafter, the consistency between the vehicle test and the VILS test is analyzed with reference to FIGS. 11A to 13H. In detail, with reference to FIGS. 11A to 13H, obtained data is classified into perception sensor data, longitudinal behavior, and lateral behavior, and test results of the two environments are compared. In FIGS. 11A to 13H, key performance Indexes (KPIs) for each classification are selected, KPIs for the vehicle test are displayed in black, and KPIs for the VILS test performed 5 times are displayed in five colors.

Hereinafter, the consistency between the vehicle test and the VILS test is analyzed using the aforementioned NRMSE, Pearson correlation, and peak ratio comparison scheme based on the results of each KPI. The NRMSE is an indicator representing an error between data sets, The Pearson correlation is an indicator representing linear correlation between two data sets, and the peak ratio comparison is an indicator for determining whether data peak values observed at specific time points, such as emergency braking in a vehicle test and a VILS test, are similar to each other.

First, referring to FIGS. 11A to 11H, the validity of the sensor modeling of the VILS system is verified by analyzing the consistency between the virtual perception sensor data generated in the VILS process and the actual sensor perception data.

As shown in FIGS. 11A to 11H, in relation to the perception sensor data, the longitudinal/lateral relative distance and relative speed of the target vehicle, which are sensor data necessary for adaptive cruise control (ACC) performed by the test vehicle, are selected as a KPI of sensor data

To ensure high consistency with the vehicle test, the virtual perceptual sensor data generated by the VILS system should be similar to the vehicle test data. This is because, when the generated virtual perception sensor data is not similar to actual data, the control command value generated by the autonomous driving algorithm may show a completely different behavior.

FIGS. 11A to 11C illustrate the case of the first scenario described above with reference to FIG. 10C. FIGS. 11D to 11F illustrate the case of the second scenario. In the first scenario, the front target vehicle drives autonomously at a fixed speed. Therefore, referring to FIGS. 11A to 11C, it may be confirmed that the relative distance and relative speed show a constant tendency after the steady state. In the second scenario, as shown in FIGS. 11D to 11F, it may be understood that the measured sensor data values are not constant compared to the first scenario because the front target vehicle is driven manually.

Meanwhile, referring to FIGS. 11A to 11F, it may be understood that the results of the 5 VILS tests performed using the two scenarios are similar to the sensor information obtained during the vehicle test.

FIGS. 11G and 11H are diagrams illustrating the result of each of the VILS test and the vehicle test. As illustrated in the table shown in FIG. 11G, it may be understood that the NRMSE of the longitudinal/lateral relative distance and the relative speed has an average value of about 2%. Even in the case of Pearson's correlation, it may be understood that it has a high positive correlation close to ‘1’. That is, it may be understood that the constructed VILS system generates sensor data similar to real conditions.

Meanwhile, the table of FIG. 11H illustrates results of comparing the relative speed of the front target vehicle measured during sudden braking at the end of the target road. It may be understood that in each of the two scenarios, the relative speed has an average error rate of less than 2.5% when compared with the vehicle test. When reviewing such comparison results, it may be understood that the virtual perception sensor data generated by the simulation device 100 according to embodiments of the present disclosure has sufficient validity.

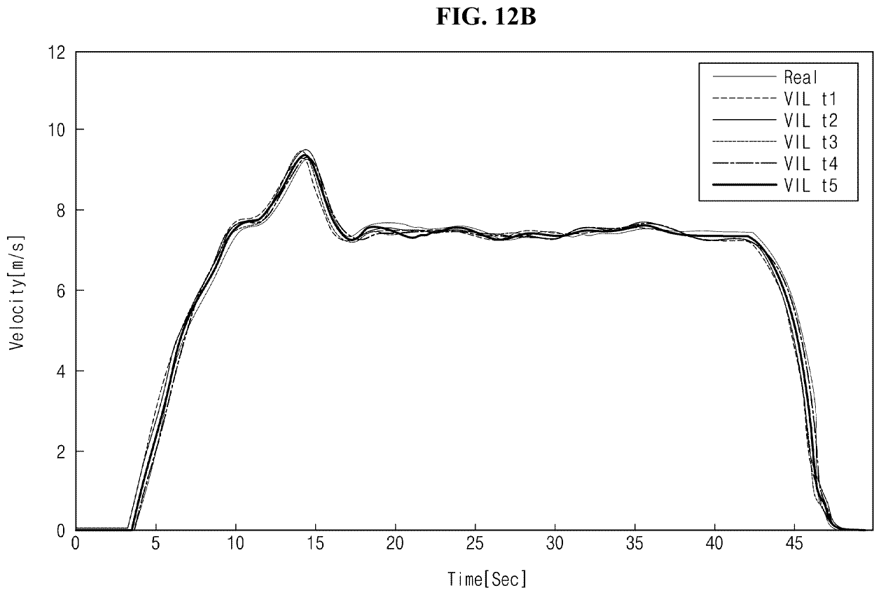

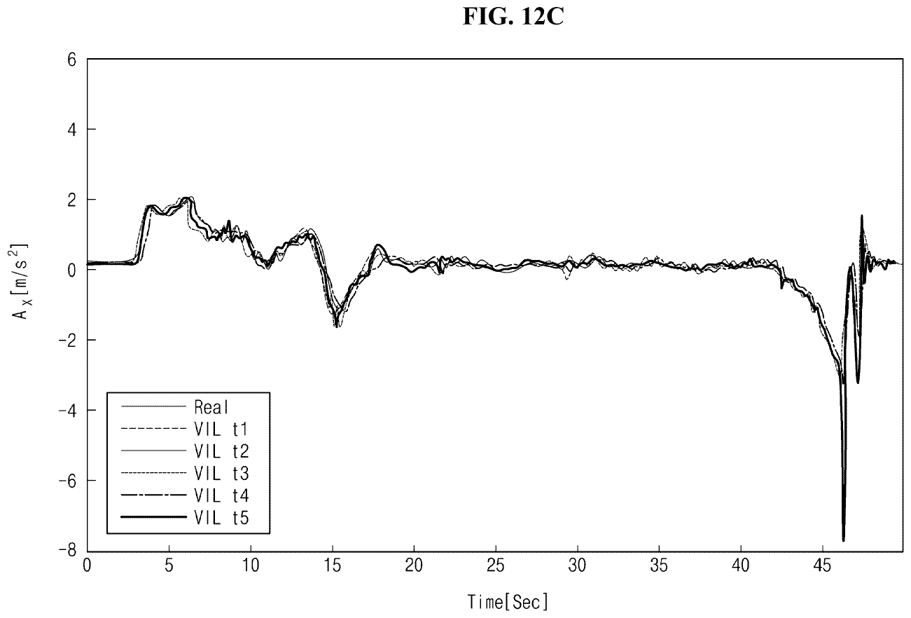

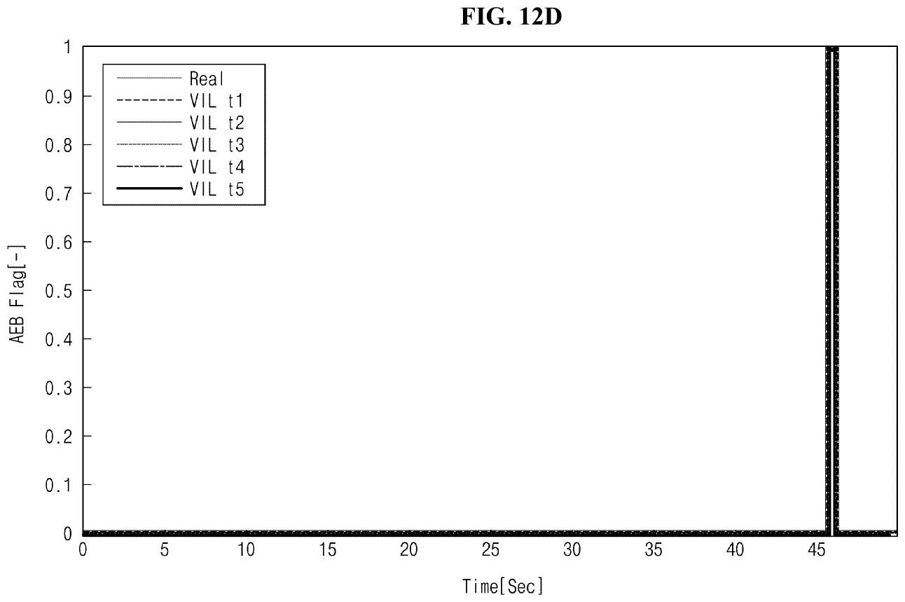

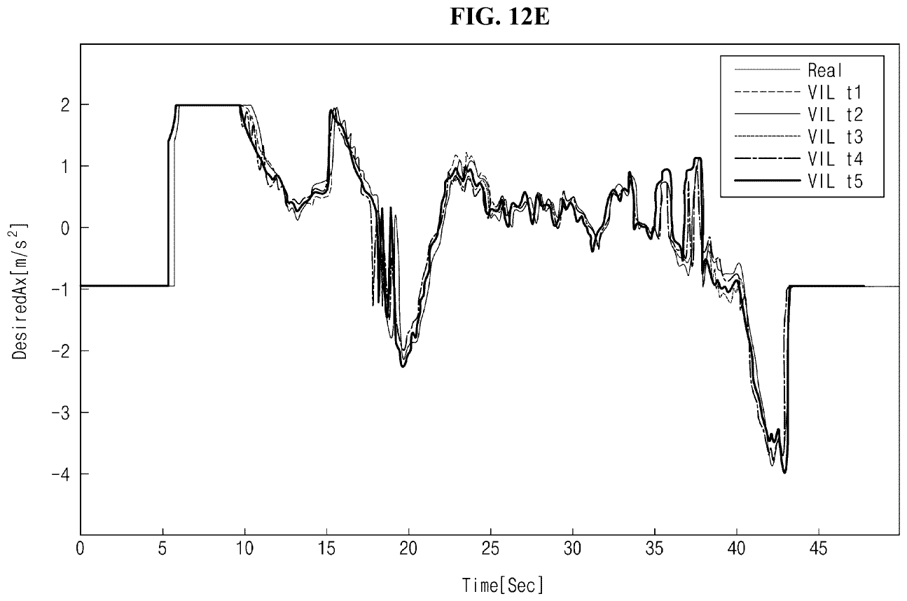

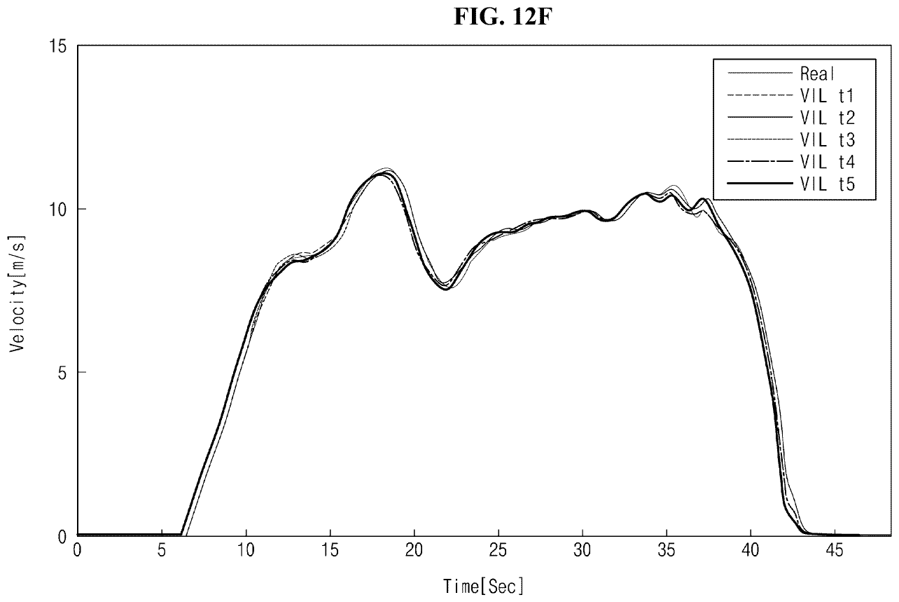

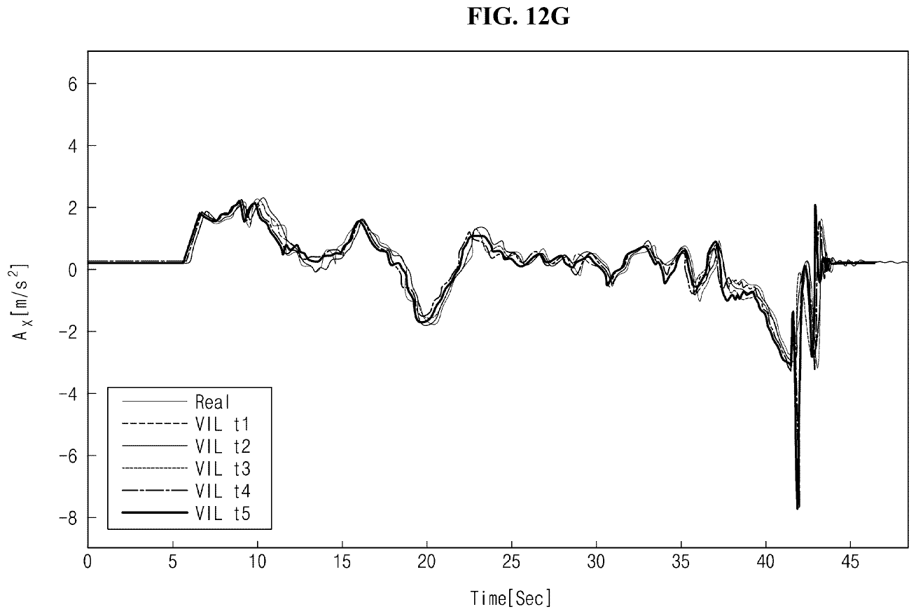

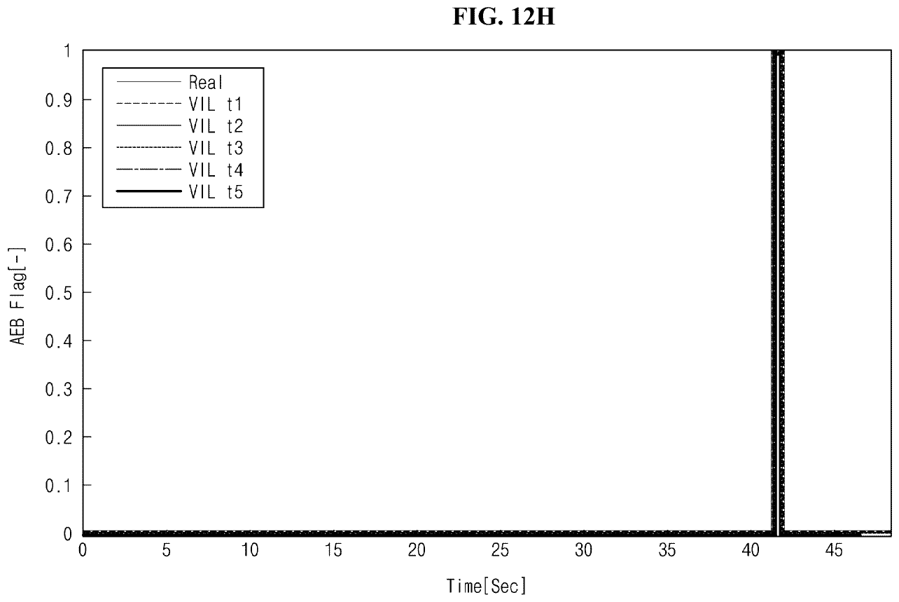

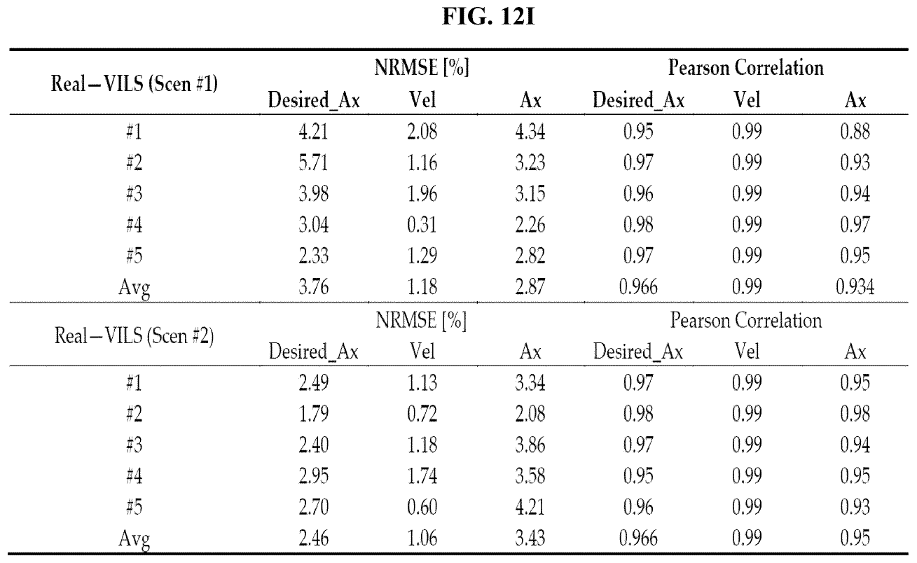

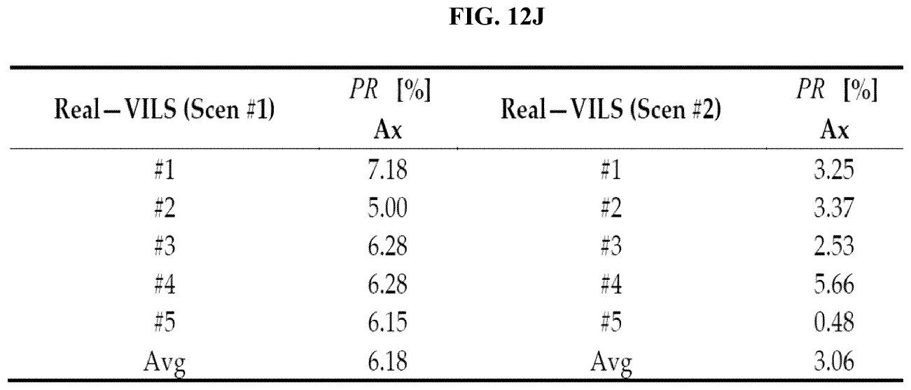

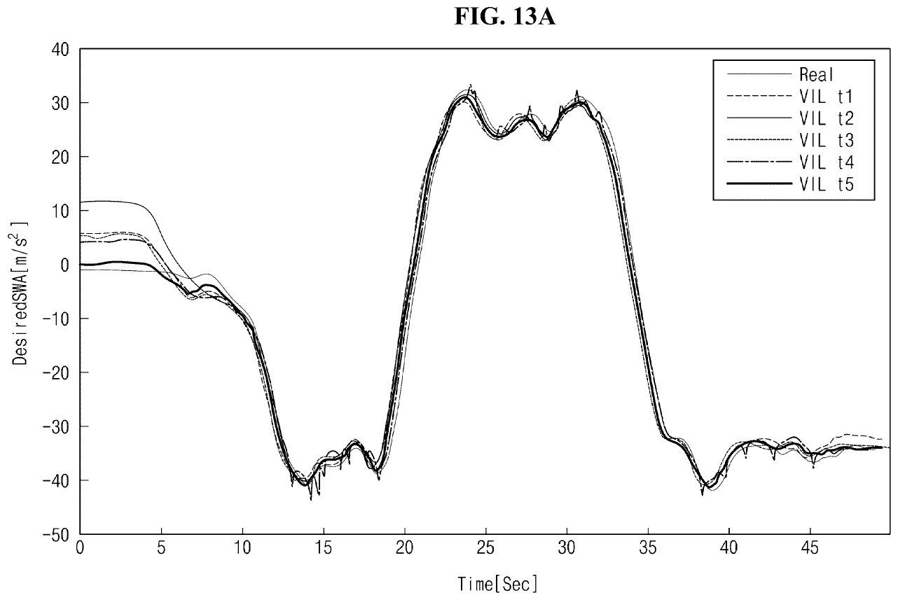

Hereinafter, the consistency of the longitudinal behavior of the vehicle test and the VILS test is verified with reference to FIGS. 12A to 12J. As shown in FIGS. 12A to 12J, in relation to longitudinal behavior, a desired acceleration, a speed, a longitudinal acceleration, and an autonomous emergency braking (AEB) flag are selected as KPIs.

FIGS. 12A to 12H illustrate the longitudinal behavior of KPIs for two selected scenarios. In the case of the first scenario, it may be observed that the values of the speed, longitudinal acceleration, and required acceleration of the autonomous driving test vehicle 200 are constant except for the acceleration section because the front target vehicle travels at a constant speed on the target road.

Because the front target vehicle is manually driven in the second scenario, the desired acceleration value is not uniformly generated unlike the first scenario. Therefore, it may be understood that the speed of the autonomous driving test vehicle 200 is maintained at a value between about 30 km/h and 40 km/h (about 8 to 11 m/s), and the longitudinal acceleration value is also changed according to the desired acceleration value.

In both scenarios, the front target vehicle performs sudden braking at the end point of the driving target road. Accordingly, the autonomous driving test vehicle 200 implements a control for activating AEB. When the set time-to-collision (TTC) condition is not satisfied, the autonomous driving controller may output an AEB flag signal even when −4 m/s², which is the minimum required acceleration calculated by the autonomous driving controller, is applied to the vehicle. At the same time, an acceleration command (−8 m/s²) required for sudden braking may be input to the vehicle actuator.

Meanwhile, referring to FIGS. 12A to 12H, it may be understood that the longitudinal behavior information obtained during the vehicle test is similar to the VILS test results performed 5 times using the both scenarios.

FIGS. 121 and 12J are diagrams showing the results of each VILS test and vehicle test. As shown in the table shown in FIG. 12I, the NRMSE for the longitudinal KPIs is within 4% on average, and the Pearson correlation has a value close to 1. Because the AEB flag is also observed at a time similar to that observed during vehicle testing, repeatability of scenarios in which the same emergency braking situation occurs at the same place and time may be confirmed.

Meanwhile, the table of FIG. 12J illustrates longitudinal acceleration peak values in the vehicle test and the VILS test, which occur in an AEB situation near the test endpoint. Referring to the table in FIG. 12J, it may be understood that the average error rate of the first scenario is 6.18% and the average error rate of the second scenario is 3.06%. Because the autonomous driving test vehicle 200 is driven on an actual test ground, the VILS test results show some errors each time.

However, because the error of each test is not at a degree that tends to differ from the vehicle test, it may be understood that the longitudinal control test performed through the simulation device 100 according to an embodiment of the present disclosure is valid.

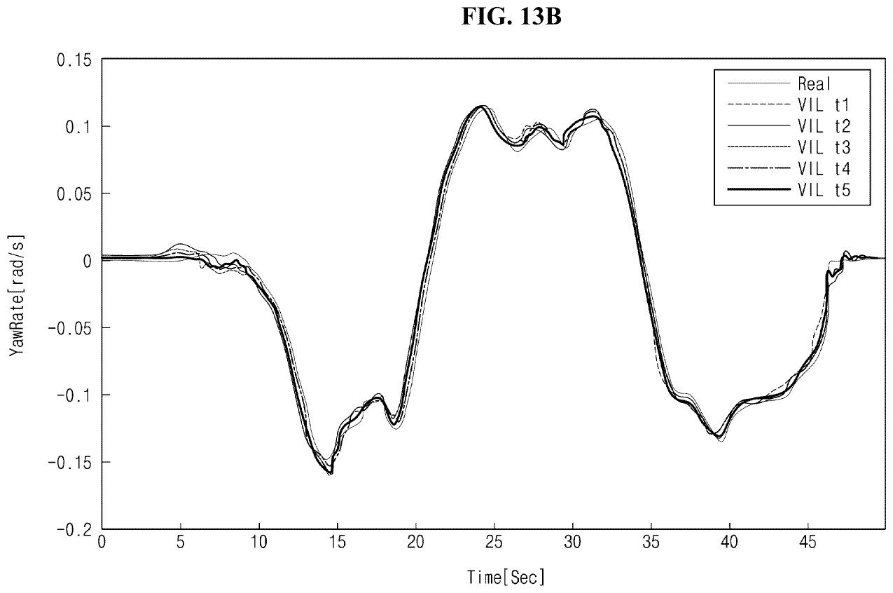

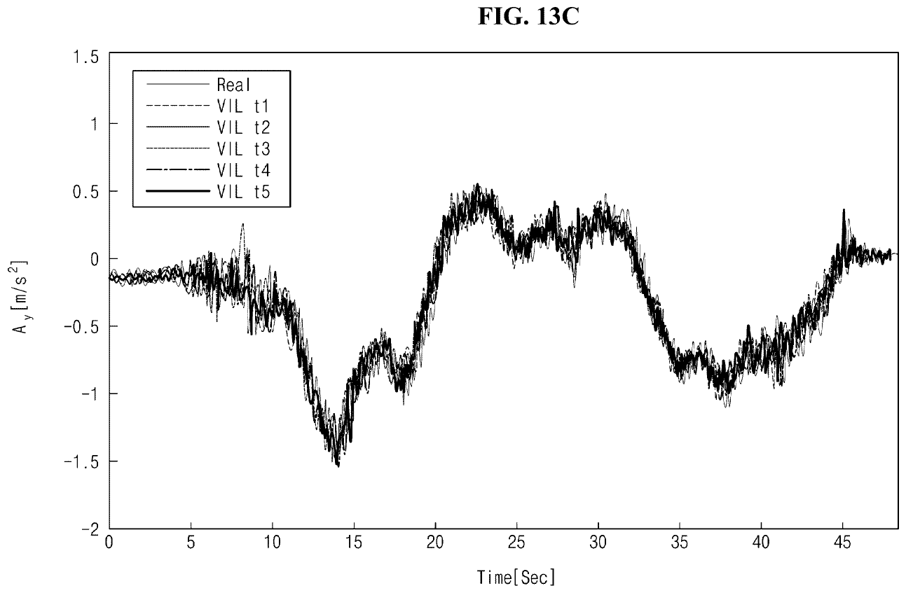

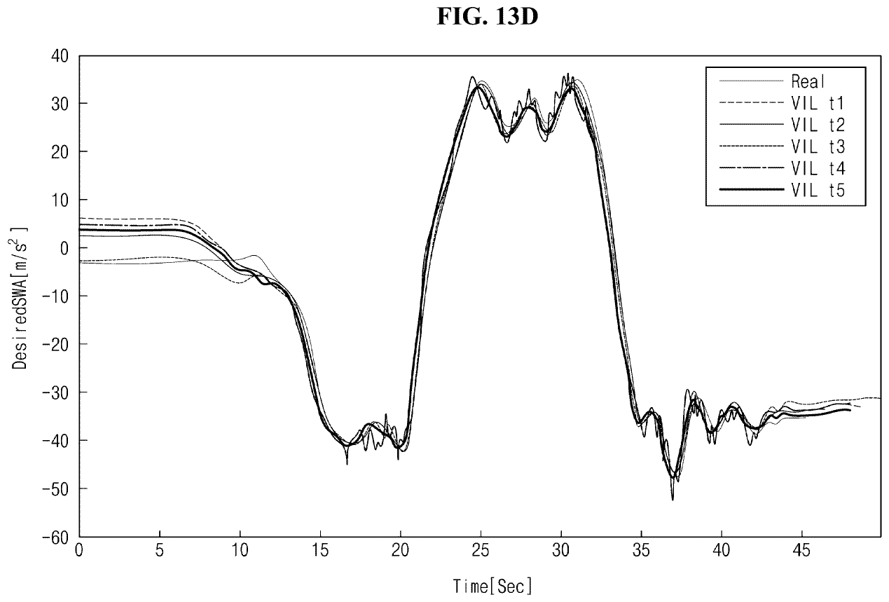

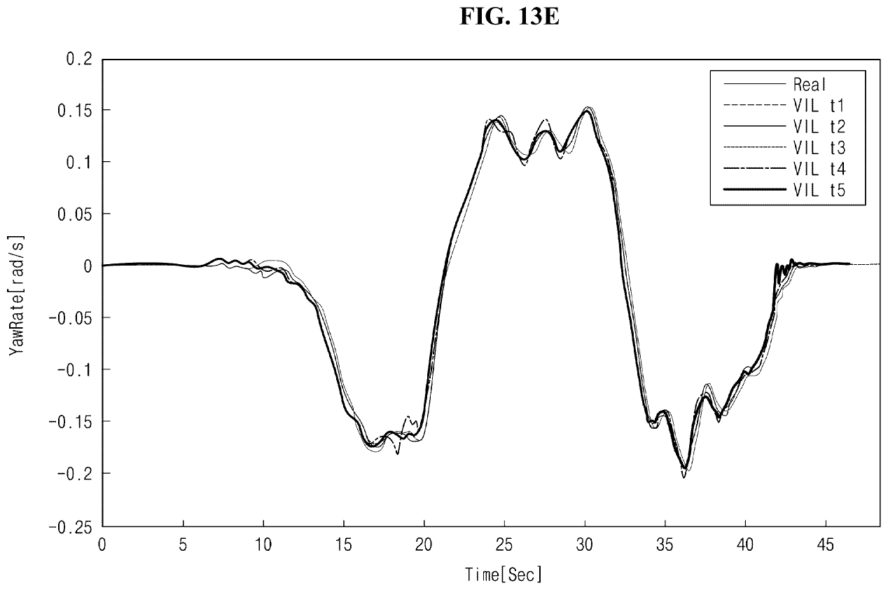

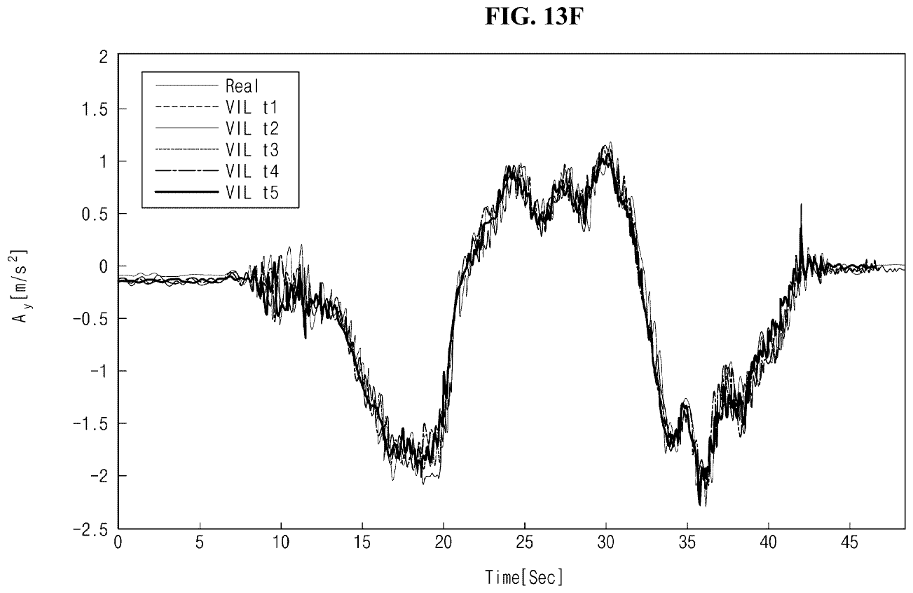

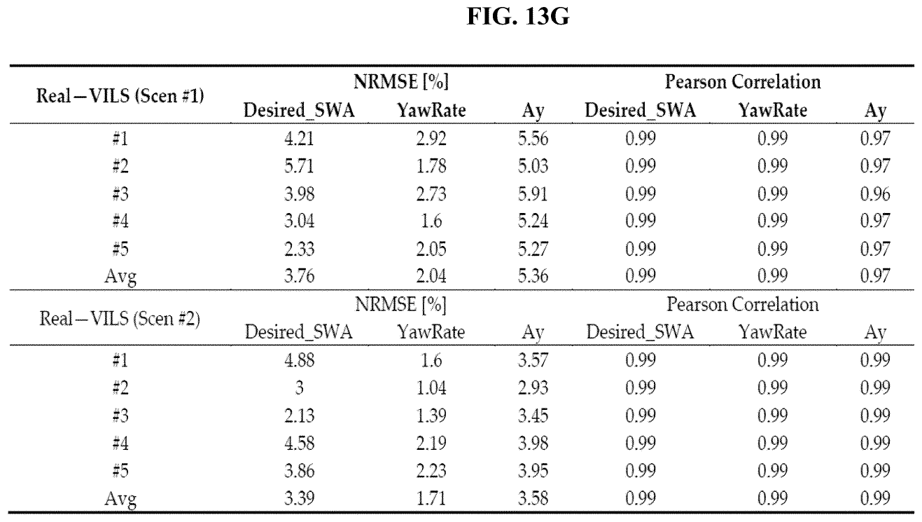

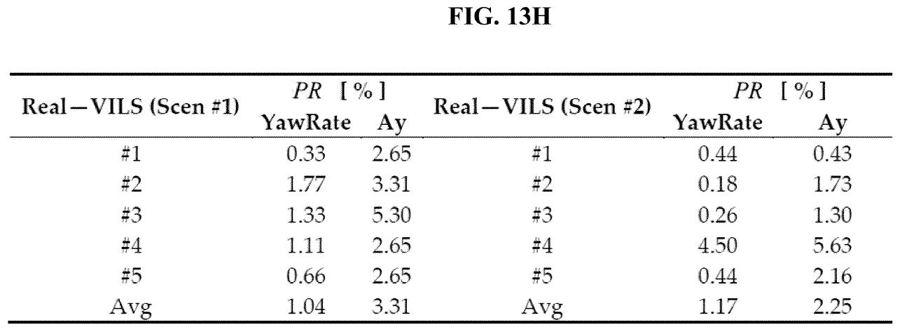

Hereinafter, with reference to FIGS. 13A to 13H, the consistency of the lateral behavior of the vehicle test and the VILS test is verified. As shown in FIGS. 13A to 13H, in relation to lateral behavior, the steering wheel angle (SWA), yaw rate, and lateral acceleration are selected as KPIs.

In the above-described two scenarios, the autonomous driving test vehicle 200 drives on a curved road (radius of curvature=70 m, 80 m, and 70 m) in three sections of the target road through path-following control. FIGS. 13A to 13F illustrate lateral KPI data of a vehicle test and a VILS test performed based on each scenario. In detail, FIGS. 13A to 13F illustrate a desired SWA generated to travel along a set route, and a yaw rate and lateral acceleration generated accordingly.

Referring to FIGS. 13A to 13F, it may be observed that the initial values of the vehicle test and the VILS test are different for the desired SWA. This error occurs because the SWA arranged at the start of the test is different for each VILS test.

In addition, referring to FIGS. 13A to 13F, it may be observed that the autonomous driving test vehicle 200 generates a desired SWA in a manner similar to that of the vehicle test, and the yaw rate and lateral acceleration are also similar to the vehicle test results.

FIGS. 13G and 13H are diagrams illustrating the result of each of the VILS test and the vehicle test. As shown in the table shown in FIG. 13G, the NRMSE for the lateral KPI is within 5.5% on average, and the Pearson correlation has a value close to 1.

However, it may be understood that the NRMSE value is higher than those of the sensor data KPI and the longitudinal KPI. This is due to the SWA of the initially aligned autonomous driving test vehicle 200, and after the autonomous driving test vehicle 200 starts driving, as described above, there is no significant difference from the vehicle test.

Meanwhile, the yaw rate and lateral acceleration values generated when turning in a curve are used for peak value comparison. As shown in the table of FIG. 13H, the maximum ratios of the scenarios are 1.04% and 1.17% for the yaw rate and 3.31% and 2.25% for the lateral acceleration ratio, respectively. That is, in both scenarios, it is observed that the peak value of the VILS test is similar to that of the vehicle test. That is, it may be understood that the lateral direction control test performed through the simulation device 100 according to an embodiment of the present disclosure is valid.

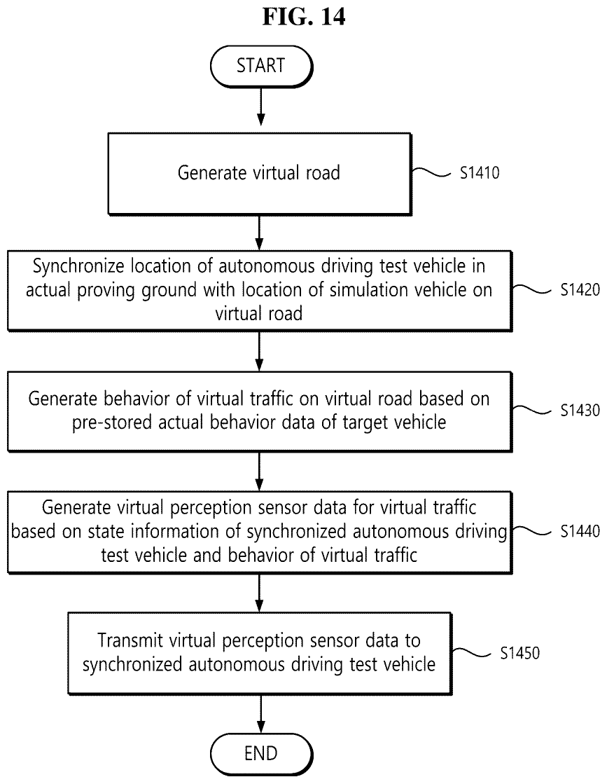

FIG. 14 is a flowchart illustrating a simulation method of a simulation device according to an embodiment of the present disclosure.

Referring to FIG. 14, the simulation device 100 may generate a virtual road in operation S1410. In this case, the simulation device 100 may convert high-definition (HD) map data of an actual autonomous driving test bed into a universal transverse mercator (UTM) coordinate system.

In operation S1420, the simulation device 100 may synchronize the location of the autonomous driving test vehicle in the actual proving ground (PG) with the location of the simulation vehicle on the virtual road.

For example, the simulation device 100 may receive actual location information of the autonomous driving test vehicle 200. In this case, the simulation device 100 may generate continuous location information of the autonomous driving test vehicle 200 by using an extrapolation scheme. Accordingly, the simulation device 100 may convert the actual location information into virtual location information on the virtual road. In this case, the simulation device 100 may convert the actual location information into virtual location information through Equation 1 described above. Accordingly, the simulation device 100 may transmit the virtual location information to the autonomous driving test vehicle 200.

In operation S1430, the simulation device 100 may generate the behavior of virtual traffic on the virtual road based on previously stored actual behavior data of the target vehicle. In this case, the previously stored actual behavior data of the target vehicle may include data on the location, speed, and direction of the target vehicle that is driven around the autonomous driving test vehicle during previously performed test driving of the autonomous driving test vehicle.

According to an embodiment, the simulation device 100 may interpolate previously stored actual behavior data of the target vehicle by using a piecewise cubic hermite-interpolating-polynomial (PCHIP) scheme, and generate the behavior of virtual traffic based on the interpolated behavior data.

In operation S1440, the simulation device 100 may generate virtual perception sensor data for the virtual traffic based on the synchronized state information of the autonomous driving test vehicle and the behavior of the virtual traffic. In this case, the state information of the synchronized autonomous driving test vehicle may include at least one of location information, speed information, and direction information measured by a real time kinematic global positioning system (RTK-GPS) mounted on the autonomous driving test vehicle. In addition, the virtual perception sensor data may include relative distance information and relative speed information between the synchronized simulation vehicle and virtual traffic.

According to an embodiment, the simulation device 100 may generate the virtual perception sensor data by reflecting information about the distance between the RTK-GPS 230 mounting location of the autonomous driving test vehicle 200 and the perception sensor mounting location, information about a RTK-GPS mounting location of the target vehicle, and information about the location at which the perception sensor 250 of the autonomous driving test vehicle 200 senses the target vehicle.

In detail, the simulation device 100 may calculate the relative distance information through Equation 2 described above. In addition, the simulation device 100 may calculate the relative speed through Equation 3 described above.

Meanwhile, according to an embodiment, the simulation device 100 may calculate error data by comparing the relative distance information and the relative speed information calculated based on the RTK-GPS 230 of the autonomous driving test vehicle 200 with data of the actual perception sensor 250 mounted on the autonomous driving test vehicle 200, and may insert normal distribution noise generated based on the calculated error data into the relative distance information and the relative speed information calculated based on the RTK-GPS. In this case, the simulation device 100 may generate the normal distribution noise through Equation 4 described above.

In operation S1450, the simulation device 100 may transmit the virtual perception sensor data generated as described above to the synchronized autonomous driving test vehicle 200. For example, the simulation device 100 may transmit the virtual perception sensor data to the autonomous driving ECU 220 of the synchronized autonomous driving test vehicle through a controller area network (CAN). Accordingly, the autonomous driving test vehicle 200 may perform autonomous driving based on the virtual perception sensor data received from the simulation device 100.

As described above, according to various embodiments of the present disclosure, it is possible to accurately reproduce driving conditions when testing an autonomous vehicle. In addition, it is possible to secure consistency between vehicle test results and VILS test results. In addition, it is possible to provide a PG-based VILS system capable of performing reliable validation of an autonomous vehicle.

Meanwhile, various embodiments of the present disclosure may be implemented as software including instructions that are stored in a machine-readable storage media that is readable by a machine (e.g., a computer). The machine, which invokes an instruction stored in the storage medium and is operable according the invoked instruction, may include the simulation device 100 according to the embodiments.

When the instruction is executed by a processor, the processor may perform the function corresponding to the instruction directly or by using other elements under control of the processor. The instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although exemplary embodiments of the present disclosure have been described for illustrative purposes, those skilled in the art will appreciate that various modifications, additions and substitutions are possible, without departing from the scope and spirit of the disclosure. Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

This work was supported by the National Research Foundation of Korea (NRF) grant funded by the Korea government (MSIT) (No. NRF-2021R1A5A1032937).

What is claimed is:

1. A simulation method of a simulation device comprising:
generating a virtual road;
synchronizing a location of an autonomous driving test vehicle in an actual proving ground (PG) with a location of a simulation vehicle on the virtual road;
generating behavior of virtual traffic on the virtual road based on pre-stored actual behavior data of a target vehicle;
generating virtual perception sensor data for the virtual traffic based on state information of the synchronized autonomous driving test vehicle and the behavior of the virtual traffic; and
transmitting the virtual perception sensor data to the synchronized autonomous driving test vehicle.

2. The simulation method of claim 1, wherein the generating of the virtual road includes:
converting high-definition (HD) map data for an actual autonomous driving test bed into a universal transverse mercator (UTM) coordinate system.

3. The simulation method of claim 1, wherein the synchronizing includes:
receiving actual location information of the autonomous driving test vehicle;
converting the actual location information into virtual location information on the virtual road; and
transmitting the virtual location information to the autonomous driving test vehicle.

4. The simulation method of claim 3, wherein the actual location information is converted into the virtual location information based on following equations:
$${X}_{vir} ( t ) = X ( t ) - ( {X}_{start} - {X}_{road} ) \\ {Y}_{vir} ( t ) = Y ( t ) - ( {Y}_{start} - {Y}_{road} ) \\ {ψ}_{vir} ( t ) = ψ ( t ) - ( {ψ}_{start} - {ψ}_{road} )$$
wherein ( )_{road} represents a starting point of the virtual road, ( )ₛₜₐᵣₜ represents a point where the autonomous driving test vehicle is located at a start of a simulation, ( )ᵥᵢᵣ represents the virtual location information, X, Y represent a global location of the autonomous driving test vehicle, and ψ represents a direction value of the autonomous driving test vehicle.

5. The simulation method of claim 3, wherein the synchronizing includes:
generating continuous location information of the autonomous driving test vehicle by using an extrapolation method.

6. The simulation method of claim 1, wherein the pre-stored actual behavior data of the target vehicle includes
data on a position, a speed and a direction of the target vehicle driven in a vicinity of the autonomous driving test vehicle during previously performed test driving of the autonomous driving test vehicle.

7. The simulation method of claim 1, wherein the generating of the behavior of the virtual traffic includes:
interpolating the pre-stored actual behavior data of the target vehicle by using a piecewise cubic hermite-interpolating-polynomial (PCHIP) method.

8. The simulation method of claim 1, wherein the virtual perception sensor data includes relative distance information and relative speed information between the synchronized simulation vehicle and the virtual traffic.

9. The simulation method of claim 8, wherein the state information of the synchronized autonomous driving test vehicle includes
at least one of location information, speed information, and direction information measured by a real time kinematic global positioning system (RTK-GPS) mounted on the autonomous driving test vehicle.

10. The simulation method of claim 8, wherein the generating of the virtual perception sensor data includes:
generating the virtual perception sensor data by reflecting information about a distance between a RTK-GPS mounting location and a perception sensor mounting location of the autonomous driving test vehicle, information about a RTK-GPS mounting location of the target vehicle, and information about a point at which a perception sensor of the autonomous driving test vehicle detects the target vehicle.

11. The simulation method of claim 10, wherein the relative distance information is calculated by following equations:
$$[ \begin{matrix}{RD}_{x} \\ {RD}_{y}\end{matrix} ] = [ \begin{matrix}{X}_{mea} - {X}_{sensor} \\ {Y}_{mea} - {Y}_{sensor}\end{matrix} ] [ \begin{matrix}cos ( - {ψ}_{ego} ) & - sin ( - {ψ}_{ego} \\ sin ( - {ψ}_{ego} ) & cos ( - {ψ}_{ego} )\end{matrix} ] \\ [ \begin{matrix}{X}_{sensor} \\ {Y}_{sensor}\end{matrix} ] = [ \begin{matrix}{d}_{x} \\ {d}_{y}\end{matrix} ] [ \begin{matrix}cos ( {ψ}_{ego} ) & - sin ( {ψ}_{ego} ) \\ sin ( {ψ}_{ego} ) & cos ( {ψ}_{ego} )\end{matrix} ] + [ \begin{matrix}{X}_{ego} \\ {Y}_{ego}\end{matrix} ] \\ [ \begin{matrix}{X}_{mea} \\ {Y}_{mea}\end{matrix} ] = [ \begin{matrix}- {l}_{x} \\ - {l}_{y}\end{matrix} ] [ \begin{matrix}cos ( {ψ}_{traf} ) & - sin ( {ψ}_{traf} ) \\ sin ( {ψ}_{traf} ) & cos ( {ψ}_{traf} )\end{matrix} ] + [ \begin{matrix}{X}_{traf} \\ {Y}_{traf}\end{matrix} ]$$
wherein ( )ₛₑₙₛₒᵣ represents the perception sensor mounted on the autonomous driving test vehicle, ( )ₘₑₐ represents the point detected by the perception sensor mounted on the autonomous driving test vehicle, ( )_{ego} represents the synchronized simulation vehicle, ( )_{traf} represents the virtual traffic, X and Y represent global coordinates, RD represents the relative distance, d represents the distance between the RTK-GPS mounting location and the perception sensor mounting location of the autonomous driving test vehicle, and l represents a distance between the RTK-GPS mounting location of the target vehicle and a point detected by the perception sensor mounted on the autonomous driving test vehicle.

12. The simulation method of claim 11, wherein the relative distance information is calculated by a following equation:
$$RV = {V}_{traf} - {V}_{ego}$$
wherein ( )_{ego} represents the synchronized simulation vehicle, ( )_{traf} represents the virtual traffic, RV represents a relative speed, and V represents an absolute speed of a vehicle.

13. The simulation method of claim 12, wherein the generating of the virtual perception sensor data includes:
calculating error data by comparing the relative distance information and the relative speed information calculated based on the RTK-GPS with data of an actual perception sensor mounted on the autonomous driving test vehicle; and
inserting normal distribution noise generated based on the calculated error data into the relative distance information and the relative speed information calculated based on the RTK-GPS.

14. The simulation method of claim 13, wherein the normal distribution noise is generated through following equations,
$$μ = \frac{1}{n} {\sum }_{k = 1}^{n} {X}_{k} \\ {σ}^{2} = \frac{\sum {( X - μ )}^{2}}{n} \\ N ( μ , {σ}^{2} ) = \frac{1}{\sqrt{2 π {σ}^{2}}} * {e}^{- ( {( x - μ )}^{2} / 2 {σ}^{2} )}$$
wherein μ represents an average of the error data, σ² represents a variance, n represents a total amount of the error data, and N(μ,σ²) represents a normal distribution with a mean and a variance as inputs.

15. The simulation method of claim 1, wherein the transmitting of the virtual perception sensor data includes:
transmitting the virtual perception sensor data to an autonomous electronic control unit (ECU) of the synchronized autonomous driving test vehicle through a controller area network (CAN), and
wherein the synchronized autonomous driving test vehicle is configured to perform autonomous driving based on the virtual perception sensor data.

16. A simulation device comprising:
a communication unit configured to communicate with an autonomous driving test vehicle; and
a processor,
wherein the processor is configured to:
generate a virtual road, synchronize location information of the autonomous driving test vehicle with a location of a simulation vehicle on the virtual road when location information of the location of the autonomous driving test vehicle in an actual proving ground (PG) is received through the communication unit, generate behavior of virtual traffic on the virtual road based on pre-stored actual behavior data of a target vehicle, generate virtual perception sensor data for the virtual traffic based on state information of the synchronized autonomous driving test vehicle and the behavior of the virtual traffic, and control the communication unit to transmit the virtual perception sensor data to the synchronized autonomous driving test vehicle.

17. The simulation device of claim 16, wherein the virtual perception sensor data includes relative distance information and relative speed information between the synchronized simulation vehicle and the virtual traffic.

18. The simulation device of claim 17, wherein the processor is configured to:
generate the virtual perception sensor data by reflecting information about a distance between a RTK-GPS mounting location and a perception sensor mounting location of the autonomous driving test vehicle, information about a RTK-GPS mounting location of the target vehicle, and information about a point at which the perception sensor of the autonomous driving test vehicle detects the target vehicle.

19. The simulation device of claim 17, wherein the relative distance information is calculated by following equations:
$$[ \begin{matrix}{RD}_{x} \\ {RD}_{y}\end{matrix} ] = [ \begin{matrix}{X}_{mea} - {X}_{sensor} \\ {Y}_{mea} - {Y}_{sensor}\end{matrix} ] [ \begin{matrix}cos ( - {ψ}_{ego} ) & - sin ( - {ψ}_{ego} \\ sin ( - {ψ}_{ego} ) & cos ( - {ψ}_{ego} )\end{matrix} ] \\ [ \begin{matrix}{X}_{sensor} \\ {Y}_{sensor}\end{matrix} ] = [ \begin{matrix}{d}_{x} \\ {d}_{y}\end{matrix} ] [ \begin{matrix}cos ( {ψ}_{ego} ) & - sin ( {ψ}_{ego} ) \\ sin ( {ψ}_{ego} ) & cos ( {ψ}_{ego} )\end{matrix} ] + [ \begin{matrix}{X}_{ego} \\ {Y}_{ego}\end{matrix} ] \\ [ \begin{matrix}{X}_{mea} \\ {Y}_{mea}\end{matrix} ] = [ \begin{matrix}- {l}_{x} \\ - {l}_{y}\end{matrix} ] [ \begin{matrix}cos ( {ψ}_{traf} ) & - sin ( {ψ}_{traf} ) \\ sin ( {ψ}_{traf} ) & cos ( {ψ}_{traf} )\end{matrix} ] + [ \begin{matrix}{X}_{traf} \\ {Y}_{traf}\end{matrix} ]$$
wherein ( )ₛₑₙₛₒᵣ represents a perception sensor mounted on the autonomous driving test vehicle, ( )ₘₑₐ represents the point detected by the perception sensor mounted on the autonomous driving test vehicle, ( )_{ego} represents the synchronized simulation vehicle, ( )_{traf} represents the virtual traffic, X and Y represent global coordinates, RD represents the relative distance, d represents the distance between the RTK-GPS mounting location and the perception sensor mounting location of the autonomous driving test vehicle, and l represents a distance between a RTK-GPS mounting location of the target vehicle and a point detected by the perception sensor mounted on the autonomous driving test vehicle.

20. A non-transitory computer-readable recording medium in which, when executed by a processor of a simulation device, computer instructions that cause the simulation device to perform operations are stored,
wherein the operations includes:
generating a virtual road;
synchronizing a location of an autonomous driving test vehicle in an actual proving ground (PG) with a location of a simulation vehicle on the virtual road;
generating behavior of virtual traffic on the virtual road based on pre-stored actual behavior data of a target vehicle;
generating virtual perception sensor data for the virtual traffic based on state information of the synchronized autonomous driving test vehicle and the behavior of the virtual traffic; and
transmitting the virtual perception sensor data to the synchronized autonomous driving test vehicle.
